(19) United States
(12) Patent Application Publication
(10) Pub. No.: US 2004/0260876 A1
(43) Pub. Date: Dec. 23, 2004

(54) System and method for a multiple user interface real time chronology generation/data processing mechanism to conduct litigation, pre-litigation, and related investigational activities

(75) Inventors: Sanjiv N. Singh, San Mateo, CA (US); Ragunath Padmanabhan, Santa Clara, CA (US); Gurunandhan R. Bhat, Dona Paula (IN)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Sanjiv N. Singh, A Professional Law Corporation, San Mateo, CA

(21) Appl. No.: 10/820,353

(22) Filed: Apr. 8, 2004

Related U.S. Application Data
(60) Provisional application No. 60/461,162, filed on Apr. 8, 2003.

(51) Int. Cl. G06F 17/60

(52) U.S. Cl. 711/117

(57) ABSTRACT

Methods and systems are provided herein for enabling enhanced data capturing for litigation, pre-litigation and related investigational environments, including through specially designed graphical user interfaces and key information prompts.

### CROSS-REFERENCE TO RELATED APPLICATION

This application claims the benefit, under 35 U.S.C. §119(e), of U.S. Provisional Application Ser. No. 60/461,162, filed Apr. 8, 2003, entitled “SYSTEM AND METHOD FOR A MULTIPLE USER INTERFACE REAL-TIME CHRONOLOGY-GENERATION/DATA PROCESSING MECHANISM TO CONDUCT LITIGATION, PRE-LITIGATION, AND RELATED INVESTIGATIONAL ACTIVITIES,” which application is hereby incorporated herein by reference.

### FIELD OF INVENTION

The present invention pertains to the field of data processing and investigation in which one or more data entry agents input, process, store, and analyze litigation-related or investigation-related data from multiple data sources.

### BACKGROUND

In litigation and related investigational work, it is necessary for attorneys, paralegals, interns, consultants and other data entry agents to review multiple data sources (documents, physical evidence, deposition testimony, video, audiotapes, etc.) to identify and evaluate such data sources in connection with the pending litigation or matter under investigation. Information is reviewed at various stages of a project (for example, inception, discovery, mediation, trial) with different objectives, ranging from collation of data sources, identification and evaluation of various legal issues, creation of a chronology for pre-trial preparation, briefing of experts, and, in general terms, gathering, recording and creation of a coherent pool of information that may be updated, queried, linked, analyzed, and modified (optionally in real-time) in order to facilitate a coherent and comprehensive review of the facts, legal issues, and other information associated with a particular matter or types of matters.

Various mechanisms currently used to process data for litigation and related investigational work include:

(i) Conventional data-specific processing mechanisms used to analyze certain specific classes of data. (i.e. Microsoft® Excel., audit specific programs, etc.);

(ii) Word processing programs which provide templates and other features to facilitate data recording, table construction, outlines, etc.;

(iii) File folders, document indexes, and other physical sorting devices used to store and classify various data sources for ready access;

(iv) Data imaging and other data storage programs which provide mechanisms by which conventional media (i.e. paper documents) may be scanned, stored, and viewed through more compact media (i.e. CDs). Such programs also include electronic tagging, electronic post-it notes, and multiple data entry agent participation; and

(v) Commercially available data processing programs such as CaseMap™, Summation™, etc. designed for litigation which allow entry of documents, generation of document lists, chronologies, and reports.

Generally speaking, the data processing agents enter data that should ultimately be parsed into data sets or data subsets. The need for this kind of parsing stems from both circumstantial and regulatory factors. On the one hand, such parsing is needed to correlate facts with legal issues, determine priority and significance of various facts and their relationships to each other and the various legal issues, and to break down complex, voluminous matters into manageable linkable submatters which may be analyzed in part and then re-analyzed in view of the overall project/case objectives. On the other hand, regulations governing the exchange of information between parties and presentation of information in judicial proceedings, quasi judicial proceedings, and other judicial contexts, require readily available, current indexes of facts and data sources which correlate to specific legal issues. Such information must often be presented to third parties with certain kinds of information, such as privileged, confidential, and/or otherwise sensitive information, redacted.

Currently, it appears that there is no single data processing solution which provides a central data processing solution for litigators that: (i) provides real-time, coherent inputting and processing of multiple data sources by multiple or single data entry agents in a manner that permits real-time data queries, automated linkage, distribution, and the other analytical parsing required by litigators (as described in part above); (ii) provides for the kind of real-time interaction between data entry agents (i.e. junior attorneys/associates) and supervisory data entry agents (i.e. partners, senior attorneys/associates) that produces more targeted and effective analysis of data sets and data subsets; and (iii) ensures coherent, uniform data entry to facilitate data homogenization and automate data linkage. Significant difficulty faced by litigators and other investigators, particularly in connection with projects involving a large volume of data sources and multiple data entry agents, include:

the inability to build a coherent report and/or chronology that reflects real-time participation of multiple data entry agents using homogenized data terms, and that constitutes a centralized pool of case data;

difficulty capturing data in a manner that facilitates rapid automated linking of facts, issues, and other data points so that linkage data is available for real-time data analysis and continued data entry;

difficulty capturing data in a manner that facilitates rapid automated linking of facts, issues, and other data points without requiring the data entry agent to identify linked issues;

difficulty processing data in real-time and sharing information as it becomes available;

lack of efficiency in tagging and linking data sources and data critical to specific legal issues;

inability to efficiently and rapidly distribute information to consultants, experts, outside counsel (current methods generally entail non-detailed overviews and/or inefficient re-review of non-core documents by experts in a manner that is both inefficient and costly);

inability to centralize recordkeeping for all data sources;

inability of multiple person litigation teams to effectively consider and evaluate in real time new issues, new factual revelations, and the impact of such revelations on continuing document review;

difficulty tracking, retaining, and locating data sources or accessing information on a particular data source without having the actual data source available;

difficulty tracking and redacting critical privileged, confidential, or otherwise sensitive information;

difficulty entering data in graphical user interfaces that do not accommodate the different data entry requirements of different classes of data (e.g. that “nuts and bolts” or “critical details” information relating to a document may be most efficiently entered separately from analytical or summary information, and may actually even be imported electronically if source document format permits);

difficulty accessing critical data (i.e. preliminary data defining the key people, parties, entities, issues, data entry agents and other parameters of a case or matter) while entering data, to facilitate enhanced data entry, linking and data analysis (“Critical data” for the purpose of this document refers to data relating to an entire case or matter. “Critical details” refers to data specific to a particular document or data source. In this document, “critical details” may also be referred to as “nuts and bolts” data for a particular data source.); and

difficulty in creating meaningful case libraries which allow for collation and analysis of fact patterns, legal issues, etc. across cases or matters and over time.

In brief, litigation often requires review of data sources and other case data by multiple data entry agents and other parties who may not be necessarily entering data. Hourly rates of experts, outside counsel, and investigators demand an efficient manner of inputting, centralizing, parsing, linking, accessing, archiving, analyzing and distributing case information in a manner that enables filtering of privileged and/or sensitive information, focus on key issues, high level summaries with appropriate data sources correlated to appropriate legal issues and comments, and generation of data source/evidence lists responsive to internal queries as well as external and judicial information/discovery requests.

There is also an increased demand for legal service providers to document the steps employed to process data in order to justify client billing or justify compliance with professional/ethical obligations. In addressing this increased demand, legal service providers must be able to minimize error through comprehensive collation, real-time data sharing, and responsive data processing designed to prompt data entry agents for key information and key issue identification and guide data entry agents in a manner that produces coherent, organized, and appropriately filtered data reports.

### SUMMARY

Accordingly, the present invention attempts to solve the problems mentioned above by creating a unique data processing system designed to achieve the fundamental objectives of litigation data processing and investigational activities. More specifically, the present invention pertains to certain systems and methods of data processing which would, among other things: (i) enable enhanced data capturing through specially designed graphical user interfaces and key information prompts, which act as uniform analytical templates and thereby ensure that data is captured in a regular, uniform manner, and which capture data in particular fields to facilitate rapid cross-linking and analysis with minimal user effort beyond the simple entry of data; (ii) enable generation of data sets and data subsets that will facilitate rapid real-time collation, distribution, sorting, etc. of certain key categories of information required for litigation, pre-litigation, investigation, diligence, and other related activities; (iii) enable dynamic and automated linking of issues, facts, people, and other entities which may be viewed in real-time within a single case and similar linking between data sets and data subsets of different cases or matters, with customized real-time viewing capabilities which permit users to access and/or use linkage data at will; (iv) enable real-time communication between data entry agents in connection with various data sets, data subsets, specific entries, data homogenization, supervisory control of data processing, queries, creation and deletion of key categories, creation and deletion of legal issues, special instructions, updates, and introduction and distribution of new or existing data sources; and (v) enable data entry agents to produce, update, and maintain in real-time, chronologies, reports, and other related data summaries where such reports are simultaneously viewable and cross-navigable with the aforementioned data entry graphical user interfaces.

One embodiment of the present invention is the creation of the graphical user interface specifically designed to elicit litigation specific information as the data entry agent processes documents or data sources. Such an embodiment would include a user-friendly data input screen consisting of various key information prompts. In a preferred embodiment, the main graphical user interface would consist of a principal evidence entry graphical user interface (which also may be referred to here and in diagrams as the single evidence entry screen/data form) designed to input all the data for a single piece of evidence or data source. Such a screen would be divided into three collapsible tiers which in an exemplary embodiment would be named: (1) “Nuts and Bolts” or “Critical Details”; (2) “Evidence Summary” or “Summary”; and (3) “Issue Analysis” or “Relevance to Issues.” The data categories (manifested by key information prompts with selectable choices or scroll down menus) captured in each tier would include the is following:

(1) Critical Details/Nuts and Bolts

Document Type

Date

Source

Evidence Code

Sender/Author

Recipient

Copied Parties

Parties Mentioned

(2) Evidence Summary

Brief Summary/Major Event or Evidence Described

Highlights/Detailed Summary

Other Event/Evidence Within Evidence

(3) Issue Analysis/Relevance to Issues

List of possible issues-select issue related to particular data source

Issue rating

Comments

Questions

Privilege Information

The collapsible tiers would function in a manner so that any single tier or two tiers could be collapsed to permit enlarged working space for the remaining tier(s). For example, if Tier 1 information had already been entered through importation of electronic data associated with electronically stored documents, the data entry agent could collapse Tier 1 at will so that the principal evidence entry graphical user interface would consist of the Evidence Summary tier (Tier 2), Issue Analysis tier (Tier 3) and the chronogrid or other real-time report residing in the bottom panel. In this manner, the data entry agent could focus only on the information actually being entered or actually of interest for each record and could enlarge the real-time chronogrid as appropriate and as needed.

In a preferred embodiment of the present invention, the principal evidence entry graphical user interface would exist for several principal categories of evidence including: documents, audio/visual media, and physical objects. In all three cases, the data entry agent may click on the appropriate tab for the type of evidence being entered, which automatically configures the principal evidence entry graphical user interface screen for entry of the particular kind of evidence. For example, if the user selects “physical objects”, under Nuts and Bolts or in the Tier 1 key information prompts section of the data entry graphical user interface, additional key information prompts (e.g. “Object Type”) unique to such evidence will appear.

In a preferred embodiment of the present invention, each of the key information prompts in the respective tiers (and in fact any key Information prompts on similar screens or any such field on similar screens) would be accompanied by various data processing tools or features, including: (i) explanatory links or mouse-overs (which provide helpful data entry tips and/or reminders while navigating through the screen); (ii) appearance of information that would appear in real-time in the right hand helper panel or similar functional space (see below) including linked data, related data statistics and query results, legal definitions, information, and/or customized data (e.g. reminder of key legal issues as entered by a supervisory data entry agent, or firm specific instructions regarding processing of certain specialized documents residing either in the firm legal database or in the critical data entered by the supervisory data entry agent at case inception or through update, or general information from a 3^{rd} party legal database or glossary); (iii) scroll down menus for appropriate data fields and key information prompts, including term recognition features, to facilitate data homogenization and automated linkage with pre-existing data records (where “data record” refers to the data from a data source as stored in the matter database and/or case library) or critical data for any given case; (iv) “Default” buttons, appearing with appropriate denotation next to all relevant data fields, which would enable a data entry agent to set particular fields or sets of fields as defaults to ensure rapid entry of documents with commonly repeated data points.

In embodiments, the “Default” or “Set Default” button functionality described above may be supplemented by additional default-setting functionalities, including the ability to save an entire principal evidence entry screen as a template through selection of a “Save as Template” option in a scroll down menu or the like, and including the ability to set default entries for selected fields such as Date, Document Type, Author, etc using a single “Set Default Button” such that the fields selected will appear with the default selection for all subsequently viewed principal evidence entry graphical user interfaces until deselected or deactivated.

In preferred embodiment, Tier 3 contains an issue list which is pre-set by a supervisory data entry agent. This pre-set issue list is created at the time a matter is created and may be updated either by the supervisory data agent or by real-time issue additions issued by data entry agents and approved by supervisory data agents. In either case, the total issue list, including pending proposed issues (see below), appears in Tier 3 and thereby provides the user with an “issue template” for guided review of each data source. The presence of this issue template ensures automated linkage of issues with facts, people, entities, dates, and other data fields, and also ensures that data entry agents are applying a complete analytical template in reviewing each data source. Like the other key information prompts, the issue list thus is both a data linkage mechanism and a quality control or instructional component that ensures more thorough data review. Issue lists for particular cases or matters may be saved and archived in the case library, and may enable a supervisory data agent or firm administrator to build issue libraries for certain classes of cases.

In embodiments, issue templates could be exchanged, updated, and collected so that a firm could deploy the same system and method described herein for multiple classes of cases or matters by varying issue templates which the firm or a third party could customize or develop for specific projects or types of cases.

In embodiments, customized key information prompts in connection with specific issues may be included or updated by supervisory data entry agents to facilitate data processing, and may draw from data already present in the matter database or case library.

In embodiments, the present invention enables a data entry agent to communicate with a supervisory data entry agent regarding creation of a new legal issue. In preferred embodiments of the invention, the mode of communication would occur through either a “Comment/Question” or an “Add Issue” button, both of which appear in the third “Issue Analysis” tier of the principal evidence entry graphical user interface. The supervising data entry agent may approve or disapprove (with comment/instructions) to all data entry agents in real-time. All such added issues and/or comments will be retained in the matter database and will be available for subsequent use in the current matter or, through the case library, future matters. Any newly submitted issue would appear in the “Issue Analysis” list of issues, and be flagged as pending by symbol or otherwise. Moreover, all queries, comments, and questions could be linked to issues, records, etc, and such linkage could be queried and or reported in a right hand helper panel or other such viewer at appropriate times or as prompted.

Another embodiment of the present invention enables a real-time homogenization of key terms through term recognition technology that is deployed at various stages of data entry For example, if a party labeled “Doe” has been identified as plaintiff (typically by a supervisory or authorized data entry agent who has entered such data as critical data in a Create/Edit Case Screen or similarly functioning screen to be incorporated in the user interface and, in the enterprise version of the system, updated through the “update” component of the user interface which appears each time a data entry agent logs in to the system), the prompt will automatically notify data entry agents of the designation and query the data entry agent whether to convert the current input into the homogenized term. Similar prompts or notifications will be prompted when entered data is matched or is similar (by phonetic or other mode of term comparison) to pre-existing data already residing in the matter database, with particular focus on names of parties, events, and key items of evidence, where such pre-existing data may come from sources including critical data (as defined in this document), previously entered data records and corresponding data sets and data subsets, other matters with identical entity names where such data resides in the larger case library, etc.

In an exemplary embodiment of the present invention, the specific term recognition technology functions as follows: As data is entered, it is subjected to a two level search. First the data is matched against an built-in (configurable) dictionary of abbreviations to obtain a list of possible expansions or equivalents and second, this list of expanded terms plus the original data entered are multi-matched with the data in the matter database (and optionally the case library). This is done dynamically so that each character typed triggers a two level search simultaneously highlighting the matched section of the typed string. As the number of characters increases, the search narrows to a few matches which are then displayed for the data entry agent to select the appropriate one. If none of the matches are appropriate (to handle the possibility that two distinct entities might share a common name or reference) the typed-in data is added to the master pool and will subsequently present itself as a candidate for a match in the appropriate circumstances.

Another embodiment of the present invention will enable one data entry agent to view all entries relevant to a specific term, homogenized term, or other key variable as of a given time. All such query and linkage functions will occur spontaneously (at selected times deemed to be times when such information is useful—for example, when the mouse is dragged over a particular issue or when an issue is being analyzed in the Issue Analysis tier) or as prompted, in the right hand helper panel or similarly distinct, simultaneously viewable space.

In embodiments, the present invention will enable the supervisory data entry agent to monitor data entry progress of various data entry agents and issue specific, private e-mail instructions to specific data entry agents on relevant points. All data entry agents will have prescribed user privileges or role definitions set at the time that a particular case is created, or during a case if desired, using an “Add User or Roles” or similarly functioning screen. Examples of default data entry agent role definitions will be as follows:

Paralegal/Secretary: enter data, import data, enter critical data/create matter with partner “key” or authorization, send messages and queries (issue analysis prohibited);

Associate: enter data, delete data (which they entered), analyze issues, send messages and queries;

Senior Associate: enter data, delete data (which they entered and which a junior entered), analyze issues, send messages and queries, monitor user performance, enter critical data/create matter with partner “key” or authorization; and

Partner: enter data, delete data, analyze issues, send messages and queries, monitor user performance, enter critical data/create matter, access all other possible functions.

In the “Add User or Roles” or similarly functioning screen or similarly configured interface, a supervisory data entry agent or authorized agent would add particular data entry agents and define their roles for that matter. The data entry agents would, by default, be selected from the data entry agents for the firm or practice which has purchased the license to the invention, where names of such data entry agents are entered through prompts upon installation of the program, uploaded from the firm's or human resource records, or otherwise added separately and in exemplary embodiments prior to matter creation through the appropriate graphical user interface. Data entry agents could also include any third party attorneys, agents, consultants or investigators who the firm decides to authorize to conduct document review through use of the invention. In exemplary embodiment, adding the user would be accomplished by selecting the “Add User” button on the matter creation or similarly functioning screen. Once the “Add User” button has been selected, the data entry agent's role can be defined according to the hierarchy set forth above; the data entry agent's role may also be customized by adding or deleting privileges from the pre-set fields for each of the defined roles. For example, a partner may decide that a senior associate should have the ability to create/edit a matter/matter's critical data and thus select this additional privilege after setting the User as a senior associate.

Another embodiment of the present invention permits real-time communication between non-supervisory data entry agents (i.e. associates, paralegals, consultants, etc.) on issues such as data source location, factual queries, term usage, discovery of new information, and other related comments. In exemplary embodiments, each member of the data entry team may be copied on responses or a centralized archive of queries and responses may be accessed by all data users. A log of the queries is recorded according to various criteria such as date, the agent submitting the query, and the agent responding to the query. Such queries may be viewed using search functions in the right hand helper panel or similar functional space or where the queries are embodied within messages between users, in a message log section of a case homepage, where clicking on a particular case name will display all recent messages for a particular case or linked to particular data records.

Another embodiment of the present invention enables a supervisory data entry agent to monitor each data source by time entered, data entry agent, location, etc. All such data would be viewable through appropriate graphical user interface.

Another embodiment of the present invention enables an abbreviated dialogue box with the essential features of data entry graphical user interfaces such as the single evidence entry screen to interface with existing data storage and viewing devices residing in a firm's own facilities (such as the CD document imaging/viewing program described above). For example, such an abbreviated user interface would enable a data entry agent using a CD or similar media document viewer to simultaneously use the electronic post-it note features of such programs such that notes on the electronic post notes will automatically appear as “legal comments” or as “evidence summaries” (as designated) in the corresponding key information prompts appearing in the abbreviated interface box. The interface box can be simultaneously viewed and completed while the data entry agent reviews and tags the scanned image of the document. Any document coding or importable data already present in the CD document database can be automatically pasted or imported into the corresponding document code box of the evidence entry user interface (and thus appear in the final report/chronology described below).

Another embodiment of the present invention will allow a data entry agent to tag selected documents for inclusion/importation such that the chronogrid or other appropriate report or data record, when viewed in Microsoft® Word or similar format or through the appropriate data record screen, will contain links which allow a user to view the imported file through a compatible viewer, or will contain hyperlinks which would allow the imported document to be viewed through an intranet or internet browser, as appropriate. This embodiment will also apply to importation of any kind of data (digital image, CADs, audio, etc.) which the data entry agent decides to import into the matter for ready access in the manner described above.

In embodiments, the present invention will allow a user to select multiple documents in certain formats (EDGAR, electronic images of documents stored on CD's) and import multiple documents at once. By importing such electronic documents or files in bulk, certain prescribed fields within the document or file will be imported to correlating data fields (corresponding to specific key information prompts) in the tiered graphical user interfaces of a single evidence entry screen or to correlating data fields within a critical data graphical user interface for a particular matter or to other correlating data fields in appropriate data entry user interfaces as described herein. For example, in a typical EDGAR file, in an exemplary embodiment, the following data would be imported to corresponding data fields in the present invention as follows:

(i)—<Form Type> (or <Conformed Submission Type>), <Description> (which would correlate to Document Type on Tier 1 “Critical Details” of the single evidence entry screen);

(ii)—<Filed As Of Date> (which should correlate to Date on Tier 1 “Critical Details” of the single evidence entry screen);

(iii)—<IRS Number>, <State of Incorporation>, and <Fiscal Year End> (which should correlate to corresponding fields of the same name in a people and organization graphical user interface); and

(iv) for the corresponding single evidence data record, the Brief Description in Tier 2 or similar data field should capture EDGAR data as follows: <Company Name><Form Type> (or <Conformed SubmissionType>)<Description> <Conformed Period of Report><Filed As Of Date>.

Another embodiment of the present invention is the chronogrid™, which, in exemplary embodiments, is a four column information grid presented in chronological order as such:

| | | | LEGAL |
|---|---|---|---|
| EVENT/DOCUMENT | DESCRIPTION | PARTIES | COMMENTS |
| | Doc code | | Legal issues |
| | summary | | |

This exemplary embodiment of the grid contains the essential format and information that will appear in many of the reports generated by the present invention. The chronogrid will appear in real-time in the bottom panel of any active data entry screen, and will be the default view while data is being entered in a single evidence entry screen. (Note that the interrelationship and structure of the four panels which surround the active data entry screen space is described below and is a novel feature in a preferred embodiment of this invention.) The chronogrid, unlike present report formats typically seen in products today, is designed to embody the essential information in a simple format that promotes report usage and reliance, and is compiled in real-time without the user having to enter the data in grid format. The columns comprise the essential elements of any data source. The bottom panel where the chronogrid is viewable may also be filled by other customized report views, including a full report grid, redacted chronogrid, timeline, etc. Each row of the chronogrid correlates to a different data record (or alternatively to an event captured within a data record); by clicking on the panel of the record, the viewer can navigate freely between the single evidence entry screen/principal evidence entry graphical user interface and the chronogrid view for the same data.

Another embodiment of the present invention will permit manipulation of the chronogrid at the request of supervisory data entry agents or authorized data entry agents such that a privileged filter will eliminate all legal comments and all documents previously tagged as legally privileged. In exemplary embodiments, any documents in which the firm's name or data entry agent(s) name appears as a party will be flagged as “suspected privileged” so that an authorized data entry agent may review and determine whether the document should be included in the redacted chronogrid that does not contain privileged information or documents. A similar filter may also be created for filtering of sensitive or otherwise confidential information.

In another aspect, a variety of other real-time reports may be generated from the data sets, data subsets, and key categories resulting from the processing of the data sources through the methods or systems of the present invention. The reports may be customized, and may reflect the results of various data mining operations performed on the data. The report may also be searchable, and may include a summary of the data, or statistical, temporal or frequency information. The report may indicate levels of productivity of a specified user. The report may also cover a specified period of time, such as a week or a month. Information in the report may be analyzed, processed, compiled, linked or organized. In addition, data contained in the report may be de-identified to provide anonymity, redaction, etc. Using the methods or systems described in the present invention, the following reports, among others, could be generated:

(i) data source lists or document lists correlating to specific legal issues for use or direct response to form interrogatories, special interrogatories, and other external information requests. The reports will be formatted accordingly, and permit direct translation of “chronogrid” information to interrogatory responses;

(ii) reports on data entry agent performance;

(iii) critical statistics for a given legal issue within a particular matter, or critical statistics for a given legal issue across various matters (i.e. relevant facts relating to an issue in all the matters where such legal issue appears);

(iv) critical statistics linking a particular fact (date, party name, organization name, event, etc) to one or more legal issues or data records; and

(v) critical statistics linking a particular fact to another fact (i.e. all the records where two different party names appear as copied parties)

Another embodiment of the invention allows a supervisory data entry agent to archive customized prompts, issues, and other related data contained in the matter database for re-use with similar projects. In this manner, each subsequent matter processed through the present invention will be better filtered due to increased customization and retention of specific key information prompts critical to parsing information for such matters. The archive of key information and key issues for a particular class of cases (e.g. construction law cases) may be housed in the firm database or case library, and can be accessed and maintained through a bi-directional flow of information from the matter database for a specific case to a similar database for that class of cases which exists as an integrated part of the law firm database or case library. Such customization may be stored in the matter database or larger case library in the form of prompts, notes, comments, data entry graphical user interface templates, case issue reports, issue-fact reports, etc.

Another embodiment of the present invention allows any data entry agent to receive immediate notification if a document or data source has been reviewed, when the data source was reviewed, and by which data entry agent. Real-time access to information will minimize the incidence of duplicative review, particularly with regards to large data sets and data subsets where allocation of review responsibilities may change over time. Information or warning prompts/notifications will be triggered if the data entry agent enters enough key information fields matching a certain prescribed set of identifying fields (e.g. the date and document code.)

Another embodiment of the present invention includes a fixed set of surrounding panels which enclose any data entry screen. The fixed set of surrounding panels remain constant as the user navigates their way through various data entry and other functional screens. The side panels, in exemplary embodiments, are as follows: (i) a top panel with status legends and the operating system task bar; (ii) a left hand case task or “current case” panel; (iii) a right hand helper panel and (iv) a bottom “chronogrid” or real-time report panel for simultaneous viewing of real-time reports while entering data. The following is a description of each panel and its functional role: (i) the top panel will be dominated by title bars clarifying to the data entry agent what is their current data entry screen. The top panel will also contain all critical task bar functions and be surmounted by the usual operating system menu or task bar; (ii) the left hand panel is the panel for major tasks relevant to a case, such as data entry, adding or editing user roles, viewing reports, and exiting to the home page. It is the main panel for navigating from screen to screen within a case, and navigating in or out of a case; (iii) the right hand panel will be the designated right hand helper panel which will display real-time data when queried or at certain prescribed times during data entry. The right hand helper panel is the main forum for analytics and real-time data accessing by the data entry agent; and (iv) the is bottom hand panel is the real-time report viewer panel, which has the primary function of displaying a chronogrid which is built in real-time as data is entered, and which would reflect all data records entered by any data entry agent in any location in the enterprise version, assuming the data entry agent was logged in and not working on a briefcase module (i.e. in the case of the module, the new data would not appear in the chronogrid until uploaded.) The real-time chronogrid is of particular significance because it allows data entry agents to view the data they are entering in conventional, spreadsheet-style format without having to enter the data in such format or remember the appropriate columns and rows into which to parse data. The cells and rows of the chronogrid are cross-navigable with data entry screens for particular data records so that a data entry agent can move freely between summarized data and data being entered, and easily access previously entered data needed for a current data record entry.

Another embodiment of the present invention includes a graphical user interface which enables exclusive entry of people and organizations for a particular matter. This graphical user interface, which may be entitled “People and Organizations” or “People and Parties” in exemplary embodiments (or similarly denoted), will be accessible through a button on the left hand “current case” task panel and will allow for a user to enter data regarding people, organizations and other such entities within a-matter so that all such people and entities are linkable to specific data records through their appearance in scroll down menus on various screens including the single evidence entry screen. As well, this interface permits a data entry agent to add more detailed data to people, parties and other such entities who have been captured through other entry modes such as the pop-up box which appears on the single evidence entry screen that permits rapid addition of a new person, organization, etc. The “People and Organizations” stand-alone graphical user interface is designed to be simple and layered so that a user can capture data only to the desired level of detail.

It is important to note that the “People and Organizations” screen or similar stand-alone graphical user interface does not have to be used in order for a party to capture and automatically link such data to particular issues and fact records. As mentioned, every single evidence entry screen provides pop-up boxes to add new parties as appropriate during the entry of a particular record. However, by providing an independent screen, the present invention aims to enable users to apply as much or as little detail and/or linkage as their desire for a specific matter. For example, a user may enter as much as possible of the total possible universe of people, parties and organizations which might appear in a matter before other users review data sources or enter any particular data records. In this manner, the users reviewing data sources will not have to enter such information themselves with as much frequency and can simply focus on the analysis of records. Linkage will be accomplished through the selection across data records of such people, parties, and other such entities in the scroll down menus of the key information prompts which appear in every single evidence entry screen correlating to specific records.

In another embodiment of the present invention, certain methods utilizing the aforementioned systems can be used to conduct litigation, pre-litigation, and related investigational document review. For example, in certain embodiments, a firm can deploy the invention so that multiple users in multiple offices can review and analyze documents for a single matter while viewing chronogrids and other real time reports reflecting the entries, queries, comments, issue additions and other input from the multiple users. In such an enterprise version or enterprise deployment of the system and methods described herein, the system and related facilities and methods may be operating by means of a network or similar electronic configuration which further enhances the function of the inherent collaboration features already embodied in the invention. For example, in one possible configuration, the invention may be deployed on a single server within an enterprise and made accessible to multiple users by means of an ASP interface that enables users to access an account through web access from any terminal. In such a manner, real time enterprise deployment possibilities are enlarged because the program can be used from any location which is ASP friendly and permits adequate screen display and hardware necessary for data entry activity. In such an example, a single matter could have a team working within the firm office entering data for certain data sources, while another team is analyzing physical evidence embodying a second set of data sources using wireless internet access from a second location, and accessing the invention by means of an internet browser with appropriate security measures enabling entry into the firm's system.

In another method, a data entry agent (e.g. a paralegal) would utilize the “People and Parties” stand-alone screen to enter all people and parties for a matter before other data entry agents analyze records. In this manner, data entry agents reviewing specific evidence records using the single evidence entry screen would only have to select parties and organizations from scroll down menus or type the first few letters of their names to trigger a match with a name in the database. In this manner, term homogenization could be ensured not just through the term recognition technology but also through encouraging users to search and select from the choices which appear in the pre-set lists which appear in the scroll down menus.

In another method, a user might upload critical data from related cases, matters or other related datasets to facilitate review of a particular matter. For example, a case library may contain two matters for the same client involving many of the same parties. Upon completion of the first matter, a user could choose to upload critical data in select modules (for example, just data correlating to people and parties, entities, etc) to facilitate review of the second matter. Other such uploadable modules would include issue lists, users roles and/or lists, query lists, comments lists, data entry GUI templates, etc.

In embodiments, the method or system may provide for paralegal or secretary users to enter Tier 1 information only, utilizing user role definition to restrict such users from doing any Tier 2 or Tier 3 analysis on any given single evidence entry screen. In this manner, a data record skeleton will already exist or could be built concurrently for matter documents, and can be displayed in the bottom panel or the right hand helper panel, so that copies of such documents can be reviewed in an order correlating to the order in which they appear in the panel and with correlating document codes. In this manner, data entry agents (e.g. attorneys, associates, expert consultants, etc.) actually analyzing issues and entering summaries in Tier 2 and Tier 3 will be able to reference pre-existing, previously entered, or concurrently entered data records with Tier 1 information without having to actually physically enter the information. Associates, attorneys and other data entry agents authorized to enter data in Tier 2 or Tier 3 can do so without having to enter as much Tier 1 data for any of the records assigned to them for review.

In embodiments, a firm may use the invention to enable outside consultants, investigators and other third parties to review portions of a particular matter with different levels of detail. For example, where it is not necessary and/or cost efficient to require a consulting expert to re-review large volumes of documents already reviewed by associates or attorneys, a user can generate a chronogrid or related reports, redacting privileged items as appropriate, and provide the chronogrid or such reports to the consulting expert. In another aspect, the consulting expert could be authorized to log in to an embodiment of the present invention contained on a laptop, utilizing a briefcase or snapshot view of the casefile, and subsequently uploading any comments or remarks made by the consulting expert.

In embodiments, data entry agents may include: secretaries, paralegals, summer associates, interns, trainees, administrative staff, associate attorneys, of counsel, expert consultants, non-expert consultants, private investigators, forensic experts, partners, clients, client staff or agents, accountants, auditors, business consultants, underwriters, and any other agent who may be using the methods or systems described here to conduct review of large numbers of documents for litigation and other investigational purposes.

In another aspect, the method or system may be used to enter data captured from a variety of different sources: documents (paper, MS Word Documents, WordPerfect files, Notepad files, spreadsheet files, electronic mail files, calendar files, presentation files, etc), audio media (tapes, CDs, DVDs, .wav files, MP3 files, and other various modes, platforms and formats for storing sound transmissions), video media (VHS tapes, BETA tapes, DVDs, streaming video files, and other various modes, platforms and formats for storing visual images), microfiche, microfilm, data storage facilities (relational databases, data repositories, data marts, object-oriented databases, disks, mass storage media, servers, jump drives, flash memory, memory sticks, or other data storage facilities). In all such cases, the method and systems provide templates for analyzing the data contained in the data source, and allow for attaching any particular source to a particular record (for references, for later viewing, etc) of the present invention.

In another aspect, the methods or systems described herein may be utilized through a variety of hardware devices: desktops, laptops, palms, PDAs, cell phones, and any other devices that would permit appearance of a single evidence entry screen, abbreviated dialogue box, or some other form of data entry graphical user interface as contemplated by the present invention. For example, Tier 1 information such as date, document type, author, and document code may appear in a single abbreviated screen on a PDA such that paralegals could enter (or scan in or import electronically) large numbers of documents on their respective PDA devices, entering factual data which could then be accessed in real-time by other data entry agents working in real-time on desktops in other locations.

These and other embodiments and uses of the present invention will be apparent to those skilled in the art from consideration of the specification and practice of the invention disclosed herein. The specification and examples should be considered exemplary only. Modified forms of the embodiments of the present invention may be used to create similar real-time data processing tools for specific legal and/or investigational disciplines (e.g. criminal investigation, scientific investigative research, medical investigative research, historical investigative research, etc.)

### BRIEF DESCRIPTION OF THE FIGURES

FIG. 1 is a schematic diagram and flow diagram indicating the flow of data during processing of data sources by data entry agents using the systems and methods embodied by the invention described in this document.

FIG. 2 illustrates an embodiment of the graphical user interface which would serve as the Main Home Page from which a data entry agent could choose to perform tasks related to cases, managing cases, managing users (i.e. other data entry agents, etc.), or searching in case libraries.

FIG. 3 is a schematic and flow diagram illustrating the possible paths which a data entry agent may take when navigating from the Main Home Page illustrated in FIG. 2.

FIG. 4 illustrates an embodiment of the graphical user interface which would serve as the Case Home Page summarizing critical data for all cases on which a given data entry agent is working.

FIG. 5 illustrates an embodiment of the graphical user interface which would serve as the principal evidence entry screen for data entry agents processing data sources using the invention. This graphical user interface is also referred to as the single evidence entry screen.

FIG. 6 illustrates the same principal evidence entry screen where data sources consist primarily of audio or video media.

FIG. 7 illustrates the same principal evidence entry screen where data sources consist primarily of physical objects.

FIG. 8 illustrates the so called “Evidence within Evidence” or “Event Within Evidence” pop-up graphical user interface which permits a data entry agent to enter multiple secondary events while entering data for a single data source.

FIG. 9 is a schematic and flow diagram demonstrating the use of the pop-up “Evidence within Evidence” or “Event within Evidence” graphical user interface illustrated in FIG. 8.

FIG. 10 illustrates an embodiment of the collapsibility of the three tiers on the principal evidence entry screen.

FIGS. 11A and 11B illustrate different views which a user may select to appear in the bottom panel of the principal evidence entry screen and other data entry GUIs.

FIG. 12 illustrates an embodiment of the pop-up graphical user interface which permits a data entry agent to add data regarding a particular party or entity while entering data for a particular data source on the principal entry evidence screen or other data entry GUIs.

FIG. 13 illustrates an embodiment of the graphical user interface which permits a data entry agent to add people, entities, or parties and related data to a particular matter at any time.

FIG. 14A and FIG. 14B are schematic and flow diagrams illustrating the possible pathways which a data entry agent may follow to enter data regarding people and parties for any given matter.

FIG. 15 is a schematic and flow diagram illustrating the importation of data from electronic data sources, linking of data sources to data records, and completion of data records using imported data and data gleaned by data entry agent review.

FIG. 16 illustrates an embodiment of the graphical user interface which permits a supervising data entry agent to create a matter, modify critical data for a matter, close a matter, or assign data entry agents and their roles.

FIG. 16A illustrates an embodiment of the graphical user interface which permits a supervising data entry agent to add data entry agents and define their roles/privileges for a particular matter.

FIG. 17 illustrates an embodiment of the graphical user interface used to add data entry agents to the firm.

FIG. 18 is a schematic and flow diagram illustrating how a supervising data entry agent may create a matter, modify a matter, modify critical data for a matter, close a matter, add or delete data entry agents or define the roles of data entry agents.

FIG. 19 illustrates an embodiment of the graphical user interfaces which serve as the principal functional panels surrounding all active data entry screens such as the principal evidence graphical user interface, the critical data graphical user interface, etc.

FIG. 20 illustrates the right hand helper panel displaying relevant data for a critical issue when the user is analyzing the particular issue in Tier 3 of the principal evidence entity graphical user interface illustrated in FIG. 5.

FIG. 21 illustrates the right hand helper panel displaying relevant data for a particular party when the party has been selected in a particular key information prompt or scroll down menu for any data entry graphical user interface.

### DETAILED DESCRIPTION

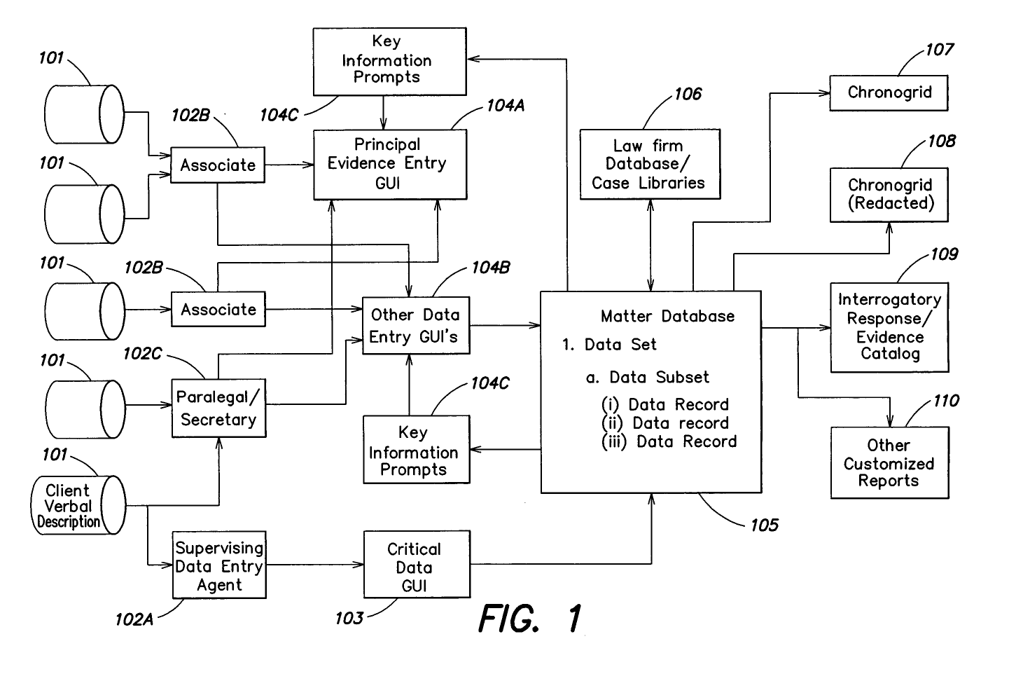

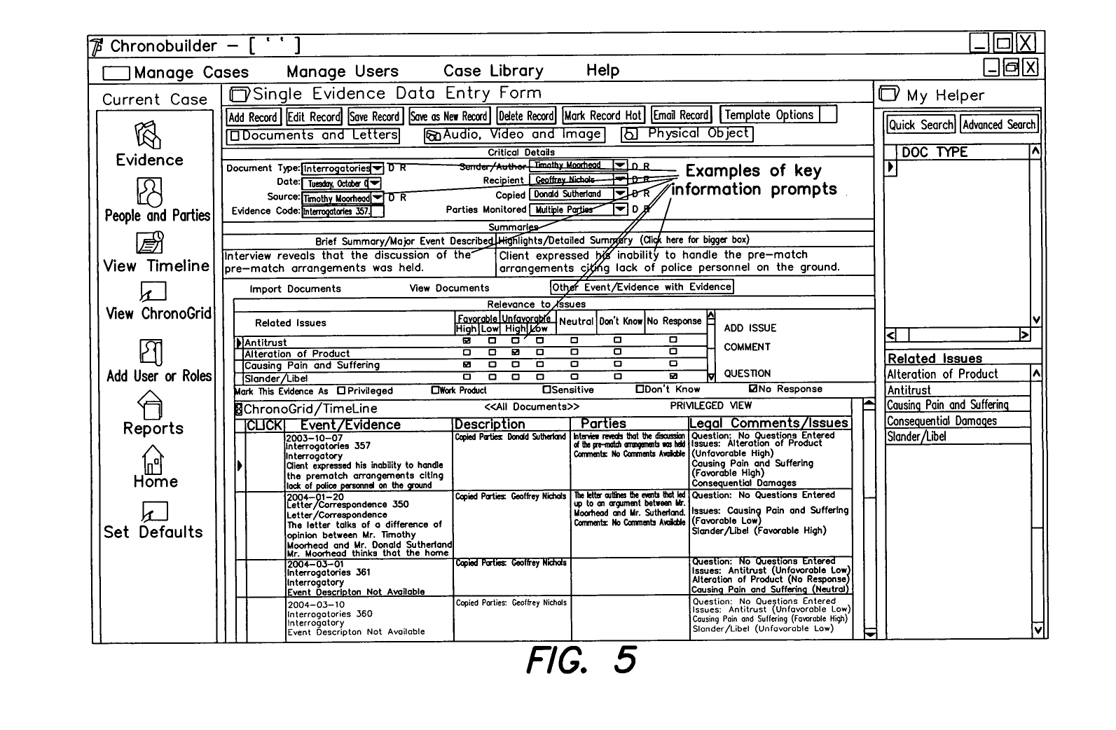

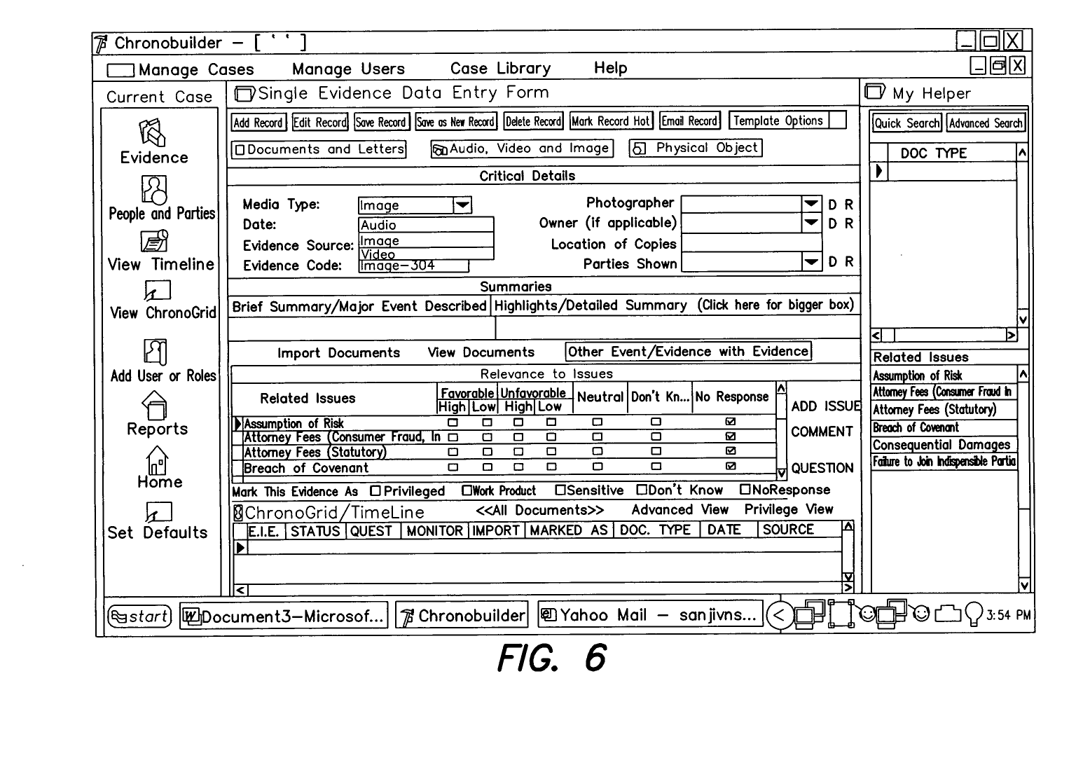

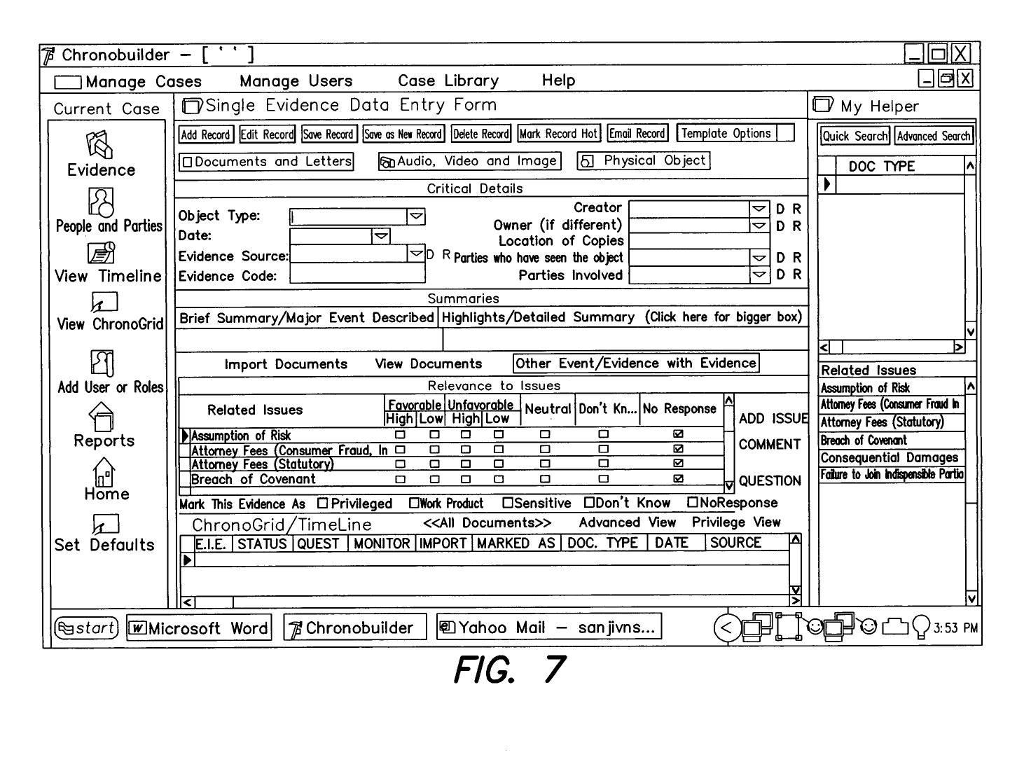

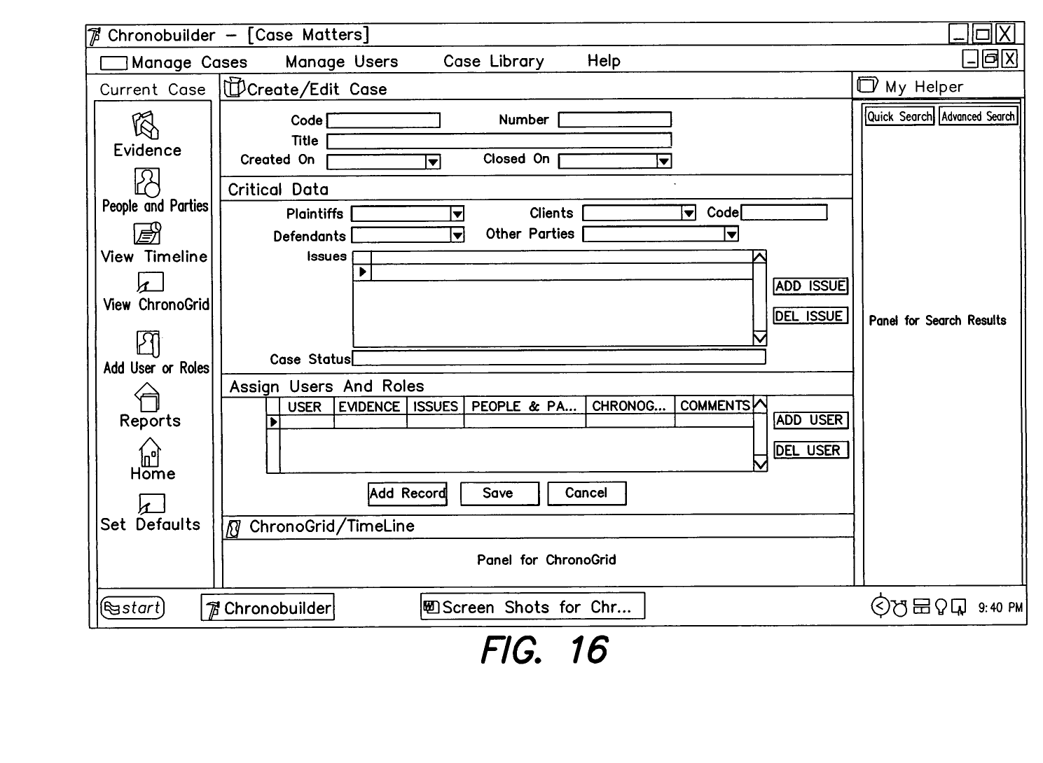

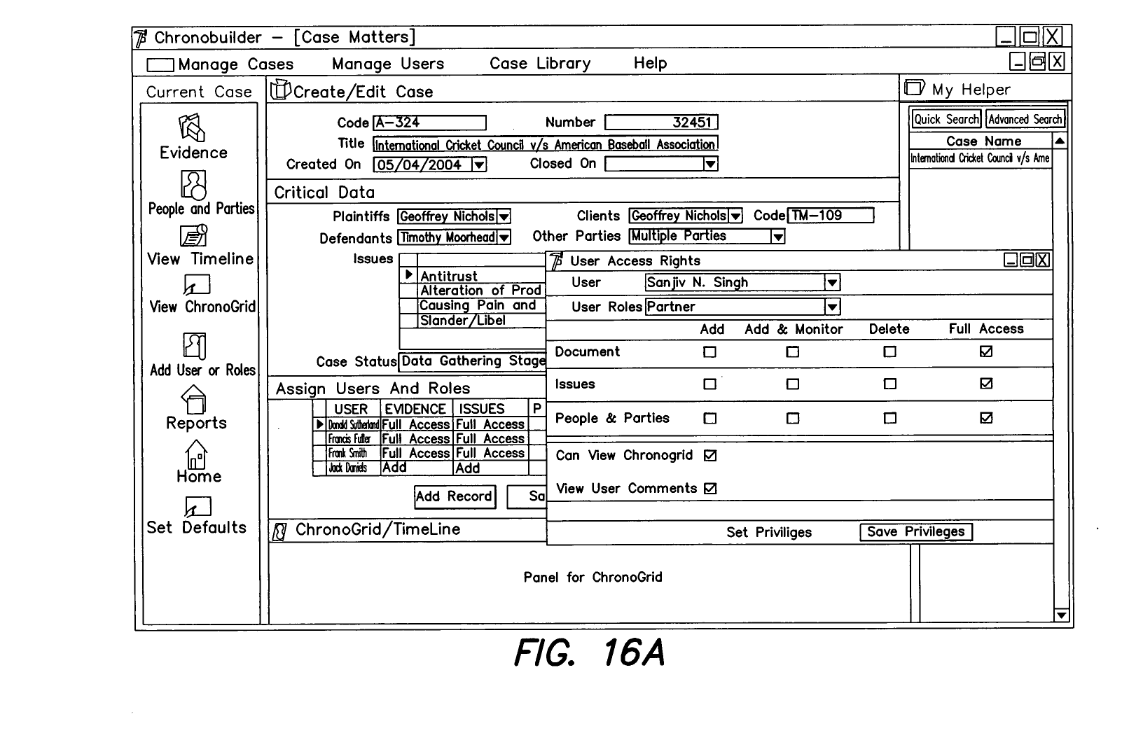

FIG. 1 is a schematic diagram and flow diagram indicating the flow of data during the processing of data sources by data entry agents using the systems and methods embodied by the invention described in this document. In an exemplary embodiment of the system and method, data entry agents 102 review a variety of data sources 101, inputting data through use of the principal evidence entry graphical user interfaces (or “principal evidence entry GUI” or single evidence entry screen as discussed above) 104A also illustrated in FIG. 5. Prior to any data entry agents 102 entering data, a supervising data entry agent (partner, senior attorney, counsel, supervising paralegal, etc.) 102A has entered critical data (i.e. name of client, key parties, key legal issues, data entry agent 102 identities and roles) through use of the critical data graphical user interface (or “critical data GUI”) 103 also illustrated in FIG. 16. The critical data is then accessible through the key information prompts 104C contained in the principal evidence entry GUI 104A also illustrated in FIG. 5 and other data entry graphical user interfaces (or data entry GUIs) 104B used by data entry agents 102. In addition, any data entered from previous data sources 101 regarding people, parties or legal issues will be similarly accessible through the scroll down menus of key information prompts 104C contained in the principal entry GUI 104A also illustrated in FIG. 5 and other data entry graphical user interfaces 104B used by data entry agents 102.

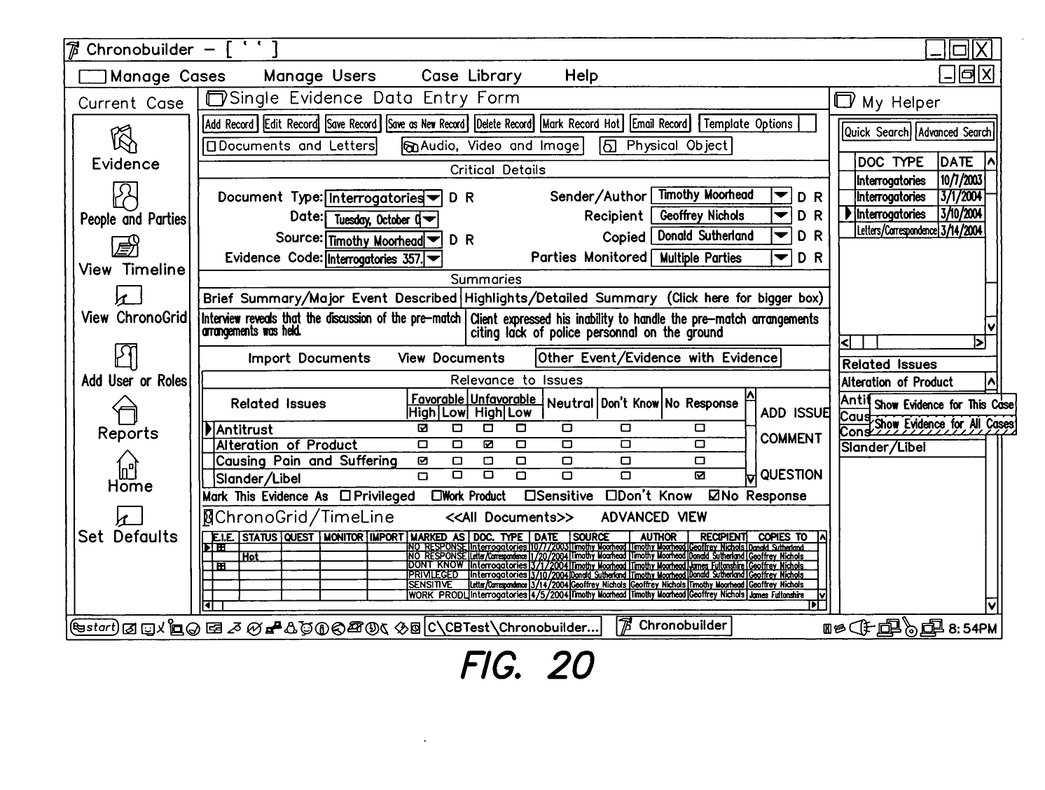

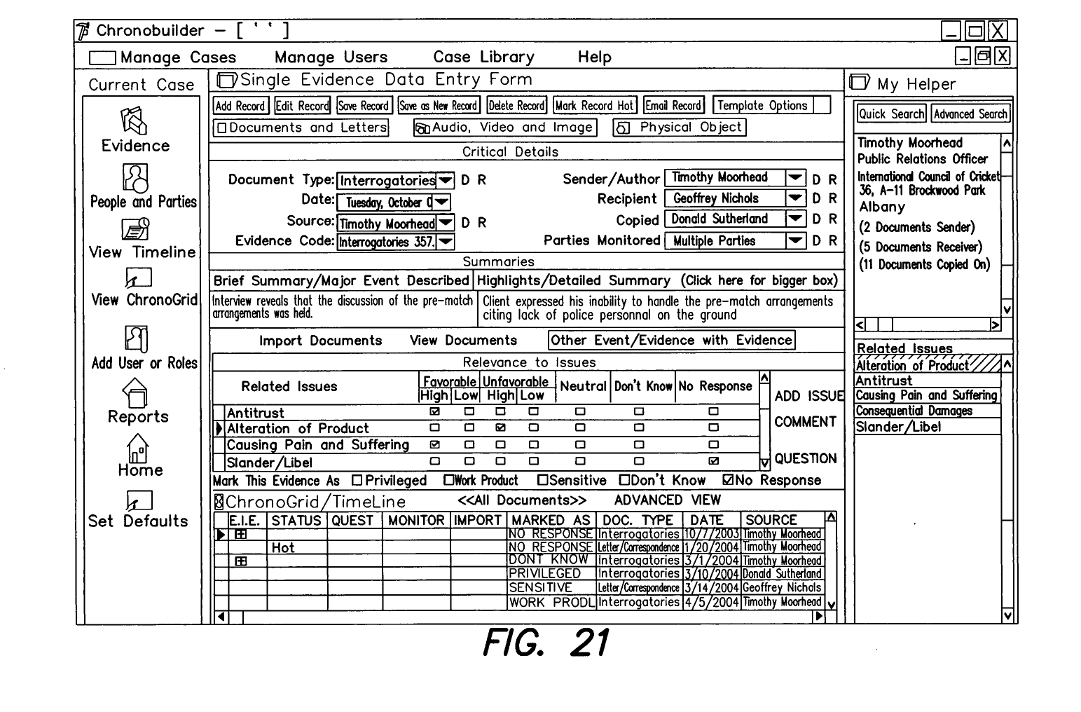

Once entered through the principal evidence entry graphical user interface 104A also illustrated in FIG. 5, data from data sources 101 will be processed and parsed in a manner that permits critical linking of facts (where such facts are entered in Tier 2 of the principal evidence entry GUI 104A also illustrated in FIG. 5) with issues (where such issues are entered in Tier 3 of the principal evidence entry GUI 104A also illustrated in FIG. 5), linking of issues with issues, linking of facts with facts, linking of facts with critical details relevant to a particular data source 101 (where such critical details are entered in Tier 1 of the principal evidence entry GUI 104A also illustrated in FIG. 5), and linking of data sources 101 with particular facts, critical details, other data sources, other data records, and/or issues, and vice-versa. Upon entry of sufficient data sources 101, critical linkage data will be viewable in the right hand helper panel described above, as illustrated in FIG. 20 or 21. For example, FIG. 20 illustrates the right hand helper panel displaying relevant data for a critical issue when the data entry agent 102 is analyzing the particular issue in Tier 3 of the principal evidence entity graphical user interface illustrated in FIG. 5. In particular, when the data entry agent 102 has clicked on a particular issue that she is analyzing in Tier 3, the corresponding issue will appear in the right hand helper panel, and the top half of the right hand helper panel will display all the relevant records where the issue has been marked as relevant. The right hand helper panel or similar functional space could also be used for real time display of similar data that reflects corresponding records from other cases. FIG. 21 demonstrates the same real time linkage data capabilities as FIG. 20 except that it illustrates real time data corresponding to a particular party where the data entry agent 102 is entering the party's name in Tier 1.

Upon entry of sufficient data sources 101 using the system and method described herein and illustrated in overview in FIG. 1 and other Figures, any data entry agent 102 may generate a variety of reports from the matter database 105 based on data records, data sets and data subsets which were mined and culled from the data sources 101 by use of the principal evidence entry graphical user interfaces 104A also illustrated in FIG. 5, other data entry graphical user interfaces 104B described in this document, and accompanying database facilities.

The reports generated by manipulation of the data sets and data subsets in the matter database 105 include but are not limited to: the chronogrid 107, a redacted version of the chronogrid 108 with shaded areas indicating redacted privileged or sensitive information, interrogatory response or evidence catalogue 109 focusing on facts is responsive to particular legal issues or queries, and other customized reports 110 which may be generated by use of a graphical user interface for report generation. This report generation graphical user interface permits creation of any of the reports mentioned in this document, and also permits generation of a linear timeline view of data sets or data subsets processed by use of this invention.

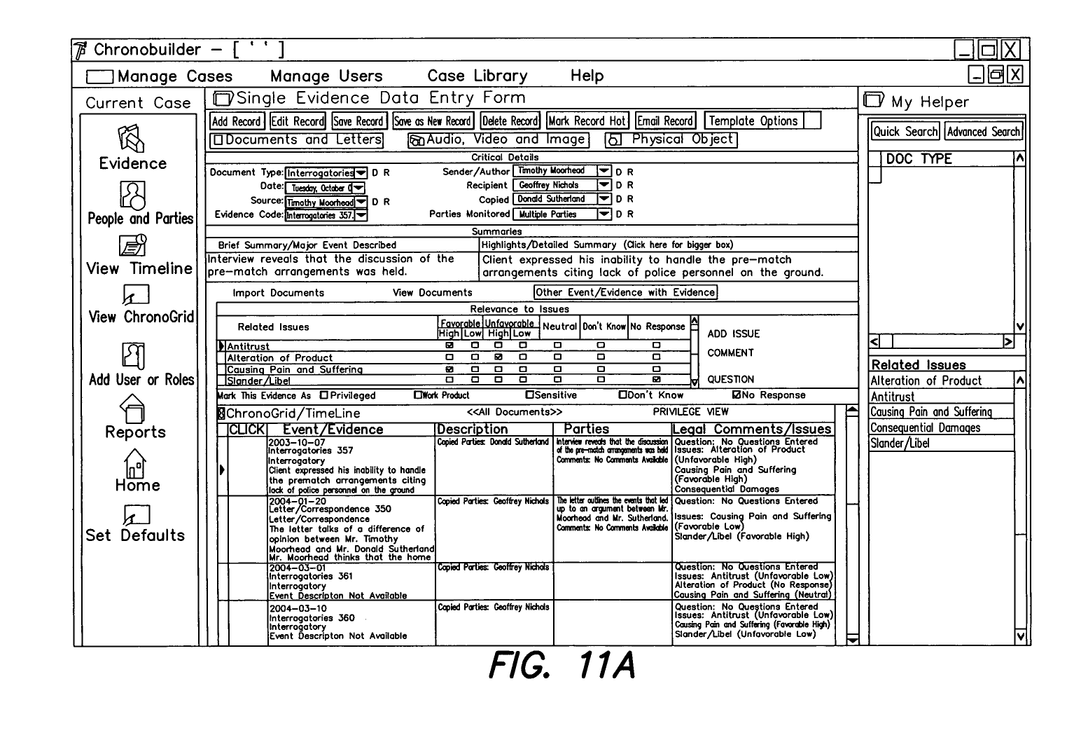

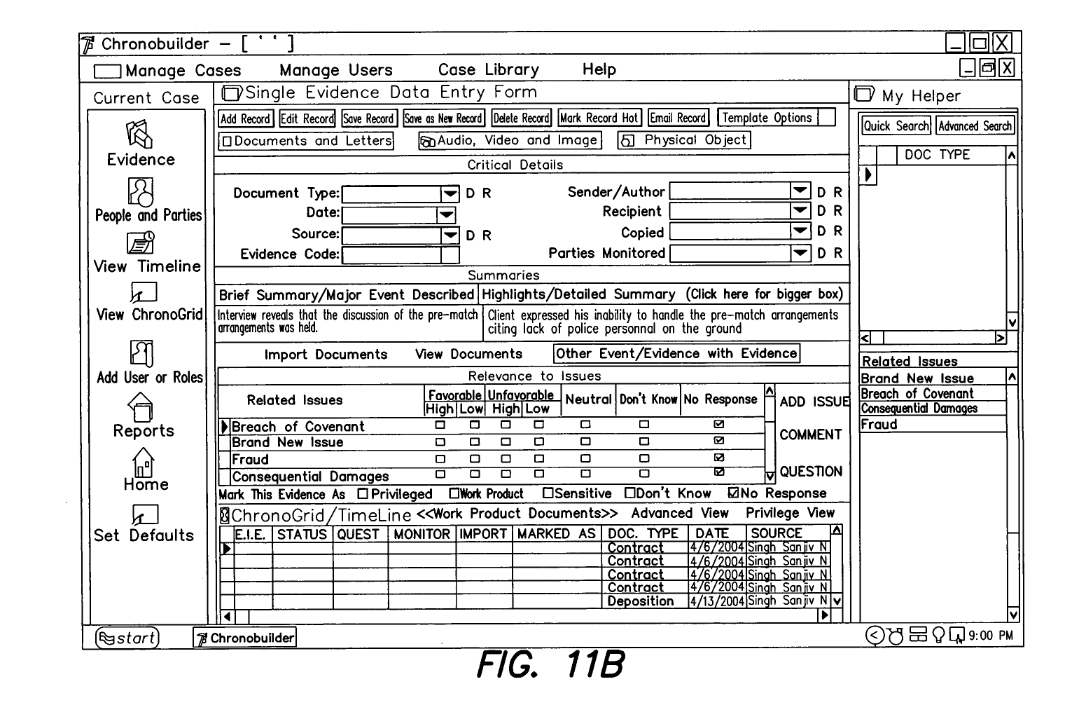

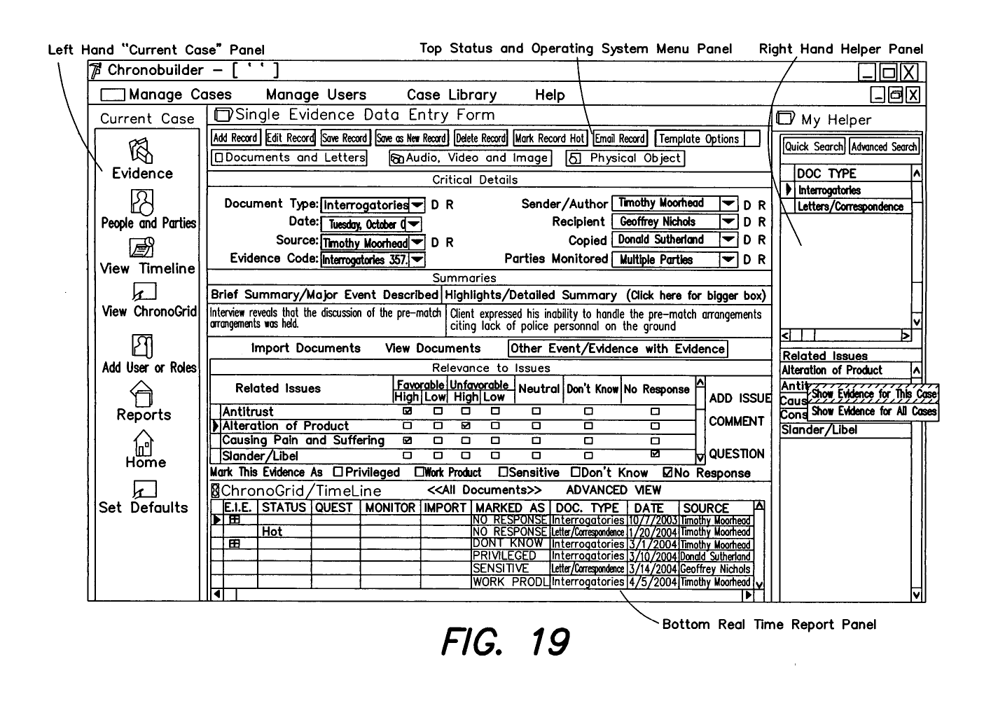

It is important to note that the chronogrid 107 and linear timeline are both readily viewable in real-time, in a bottom panel as illustrated in FIG. 11 which appears at all times with the principal evidence entry GUI 104A as illustrated in FIG. 5. (The bottom panel is one of four universal panels, as illustrated in FIG. 19, which surround the active screen space at all times that data is being entered by use of the method and system described herein.) The chronogrid 107 is modified and appears in the bottom panel in real-time according to the data sources 101 which are entered in the principal evidence entry GUI 104A such that a new row or rows as appropriate are added to the real-time chronogrid 107 after a data entry agent 102 has saved a particular data record for a data source 102 processed using the system or method. The real-time chronogrid 107 and other reports may contain cells which are linked to particular key information prompts 104C appearing on the principal evidence entry GUI 104A also illustrated in FIG. 5. In this manner, a data entry agent 102 who is entering a particular data source 101 can view the summarized data in the real-time chronogrid 107 (see bottom panel below Tier 3 on FIG. 5) and reference, copy, or paste it while entering a subsequent data source 101 using the applicable data entry graphical user interface. The data entry agent 102 can also edit a data record corresponding to a data source 101 by locating the data record on the chronogrid (i.e. the corresponding row or cell) and clicking on the cell or row of the real-time chronogrid 107, thereby pulling up the corresponding principal evidence graphical user interface 104A for that particular row or cell.

The data sets and data subsets comprised of all the data records for a given matter, all of which make up a matter database 105, may also be used to build a law firm database or case library 106 compiling and linking various data sets and data subsets from various case matters. Thus, using the search functions located in the right hand helper panel as illustrated in FIG. 19 or similar functionalities, a data entry agent 102 may search a particular data set or data subset across various case matters. For example, a data entry agent 102 could search all the data records where a particular party was linked to a particular issue. The search would query all of the data sets corresponding to this query, and could thereby generate statistics (and a report if desired using the report generation graphical interface mentioned above) which summarizes the data records (and case matters) where a particular party was linked to a particular issue, and the accompanying critical details and other data linked to each of those records.

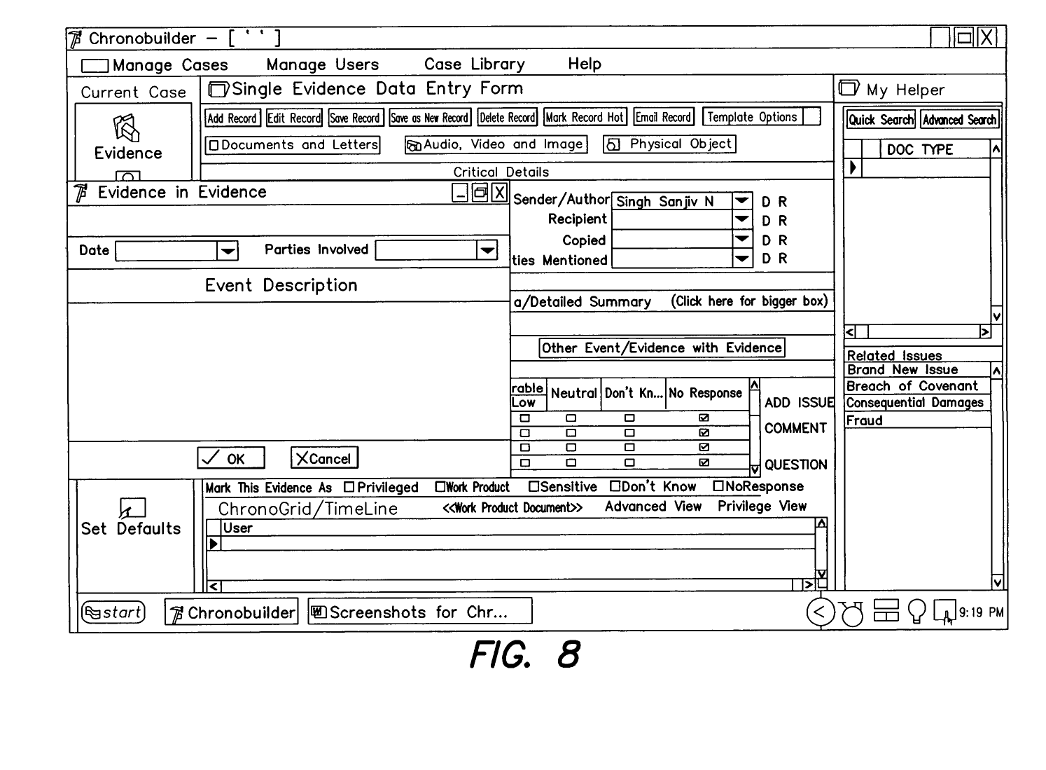

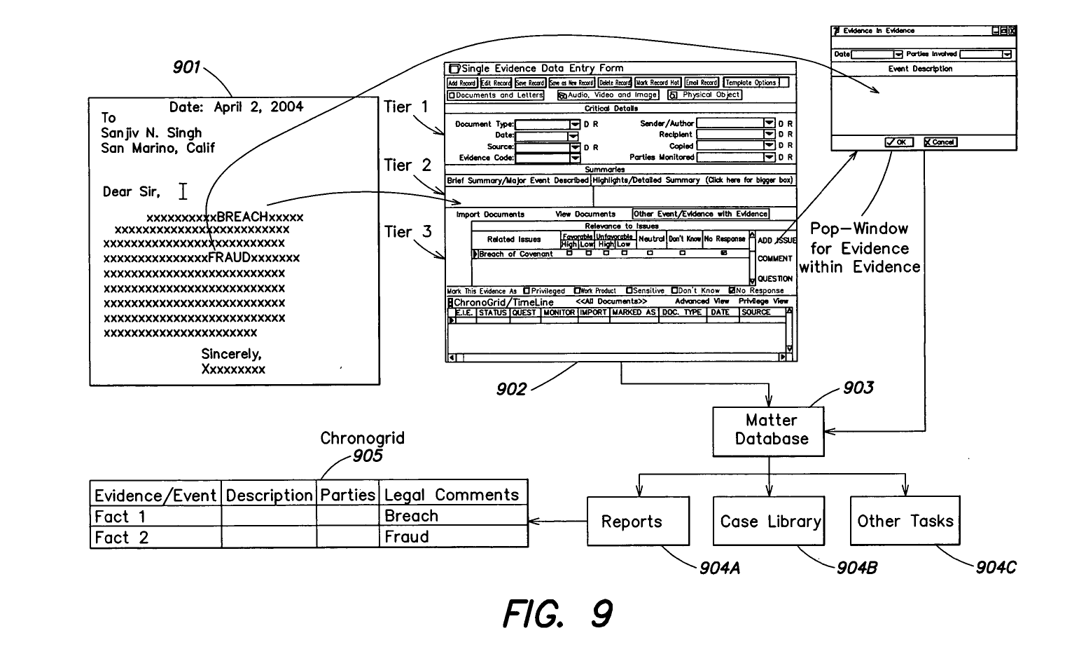

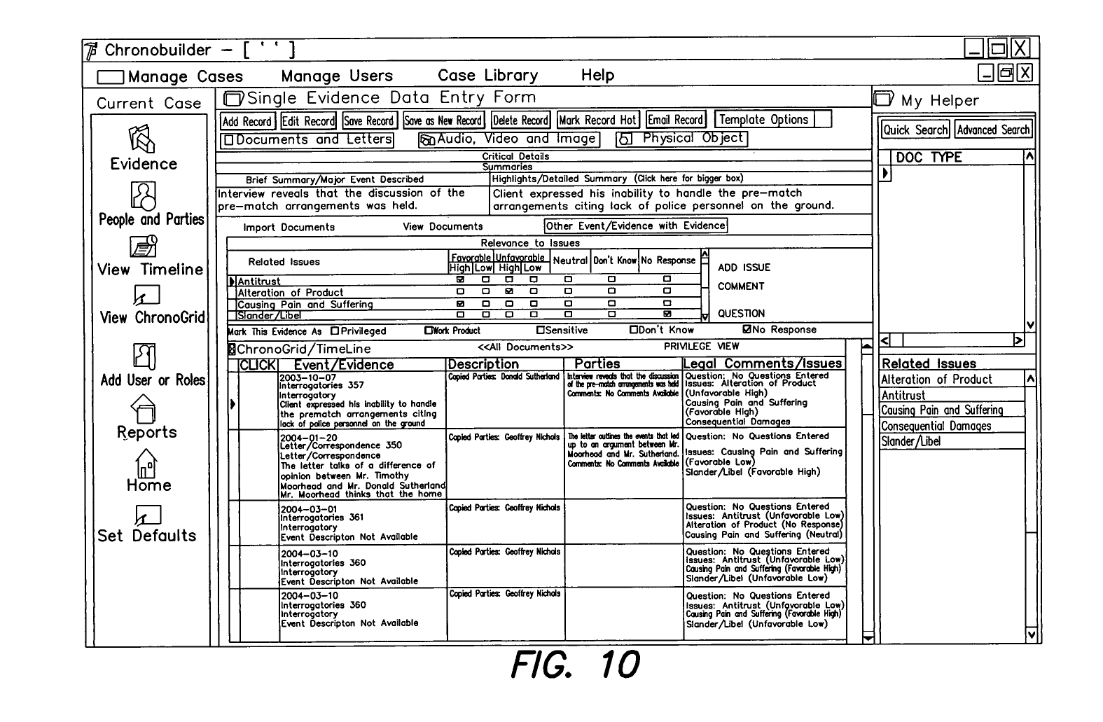

FIG. 8 illustrates the pop-up graphical user interface which permits a data entry agent 102 to enter multiple secondary events or facts of varied significance while entering primary events or facts all for a single data source 101. The so-called “Evidence within Evidence”™ or “Event within Evidence”™ or “E squared”™ pop-up graphical user interface illustrated in FIG. 8 and in 902 on FIG. 9 permits a data entry agent 102 to capture secondary events and evidence which may occur within a given data source 101, in addition to the core evidence and facts embodied by such data source 101. In this manner, a data entry agent can ensure that a secondary fact or event of potential significance will appear as its own row on appropriate reports and timelines, even if the only supporting evidence is the data source in which it appears as a secondary matter. In this manner, a data entry agent will capture facts at multiple levels and be less likely to neglect an event or fact whose significance may not emerge until later in an investigation. It also allows data entry agents 102 to automatically, and in real-time link such secondary events or evidence to a data source until such time as they may be able to locate more direct evidence or data sources. For example, as illustrated in FIG. 9, if a data entry agent 102/902 is reviewing a data source 101/901 which is a correspondence written by the CEO of a company to the CFO of the company where the letter's primary significance is that the CEO issues specific instructions regarding actions which constitute a breach of contract, the correspondence may be recorded as such with the appropriate date recorded in the key information prompt of the corresponding principal evidence entry GUI 105/902; at the same time, if the same letter references a prior phone conversation on another date (different from the date of the data source and main event) between the CFO and CEO relating to fraud, the “Evidence within Evidence” or “Event within Evidence” pop-up graphical user interface illustrated in FIG. 8 and in 902 on FIG. 9 enables a data entry agent 101/901 to record the phone conversation as a separate event or piece of evidence with its own date and corresponding issue analysis that will appear on the chronogrid 905 while still being linked to the data record corresponding to the original data source 101/901 (i.e. the letter instructing the CFO to take actions constituting a breach of contract.) In summary, the “Evidence within Evidence” or “Event within Evidence” graphical user interface 902 illustrated in FIG. 8 enables a data entry agent 102/902 to capture levels of data and events which otherwise might not appear on a conventional timeline or data record. Of equal importance, it enables the linkage of multiple facts (i.e. events) to a particular data record and/or data source 101/901, while at the same time allowing such facts to appear as independent pieces of evidence when appropriate on reports, timelines, chronogrids, etc.

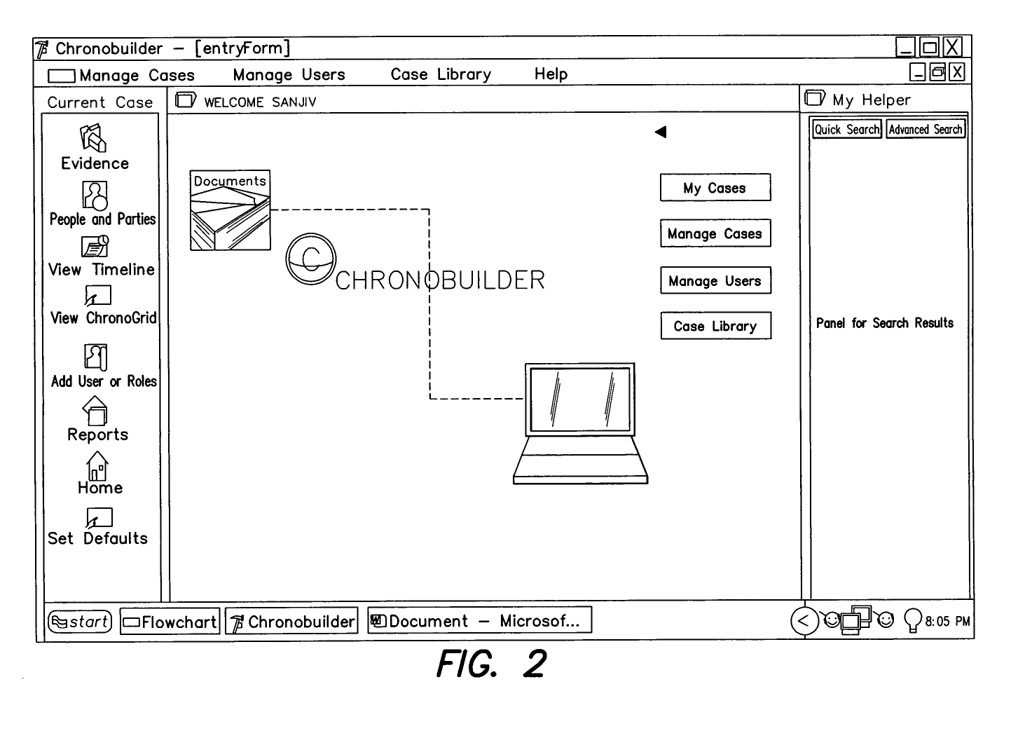

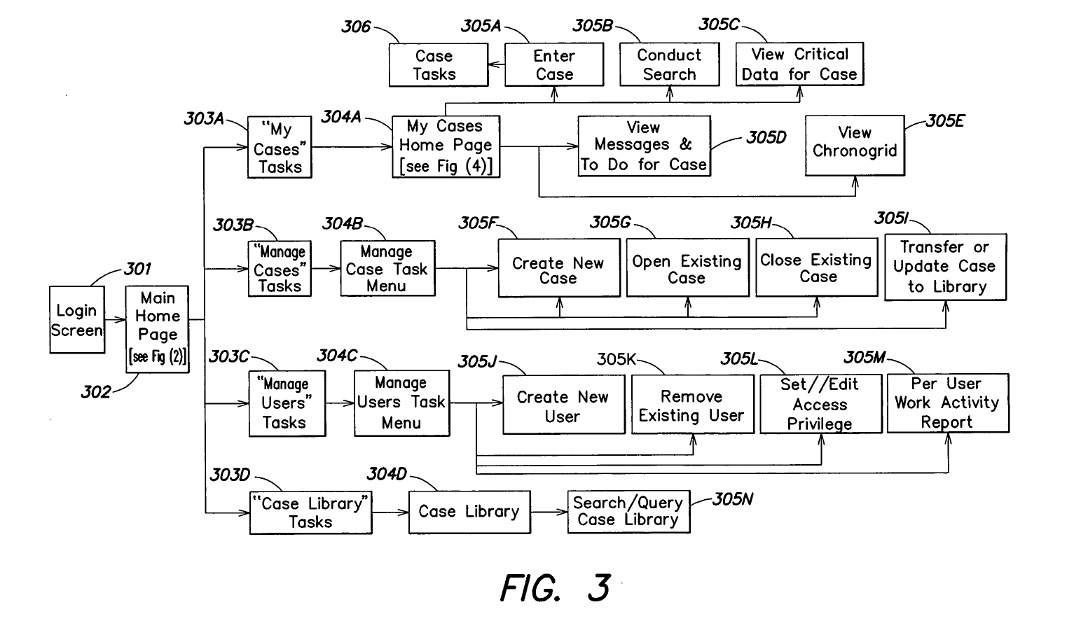

FIG. 2 illustrates an embodiment of the graphical user interface which would serve as the “Main Home Page” from which a data entry agent could choose to perform tasks related to cases, managing cases, managing users (i.e. other data entry agents 102) or searching in case libraries 107. The Main Home Page illustrated in FIG. 2 of the present invention would serve as the initial point of entry for any data entry agent 102 who has just logged into the program embodied by the invention and used by the systems described in this document. The flow diagram illustrated by FIG. 3 illustrates a data entry agent's 102 entry into the program and possible tasks which may be performed from the Main Home Page. Note that, as illustrated in FIG. 2, the program intentionally creates a certain level of redundancy between the left hand panel “Current Case” task bar, the menu bars at the top of the screen, and the tasks listed on the home page space itself. In this manner, a data entry agent 102 has multiple pathways to achieve the same task, facilitating ease of use depending on the stage of review being performed by the data entry agent 102. Thus, if a user has just logged on through login screen 301, they can select from the main menu (represented by 303A-303D) appearing in the active space (i.e. the central part of the screen—see FIG. 2) of the Main Home Page 302. On the other hand, if they are already presently working on entering a data source 101 through use of a principal evidence entry GUI 104A which occupies the central screen, the data entry agent 102 can still access core tasks through the top panel menu bar, and in the case of case critical tasks, can access such tasks through the left hand panel “current case” task bar as shown in FIG. 2.

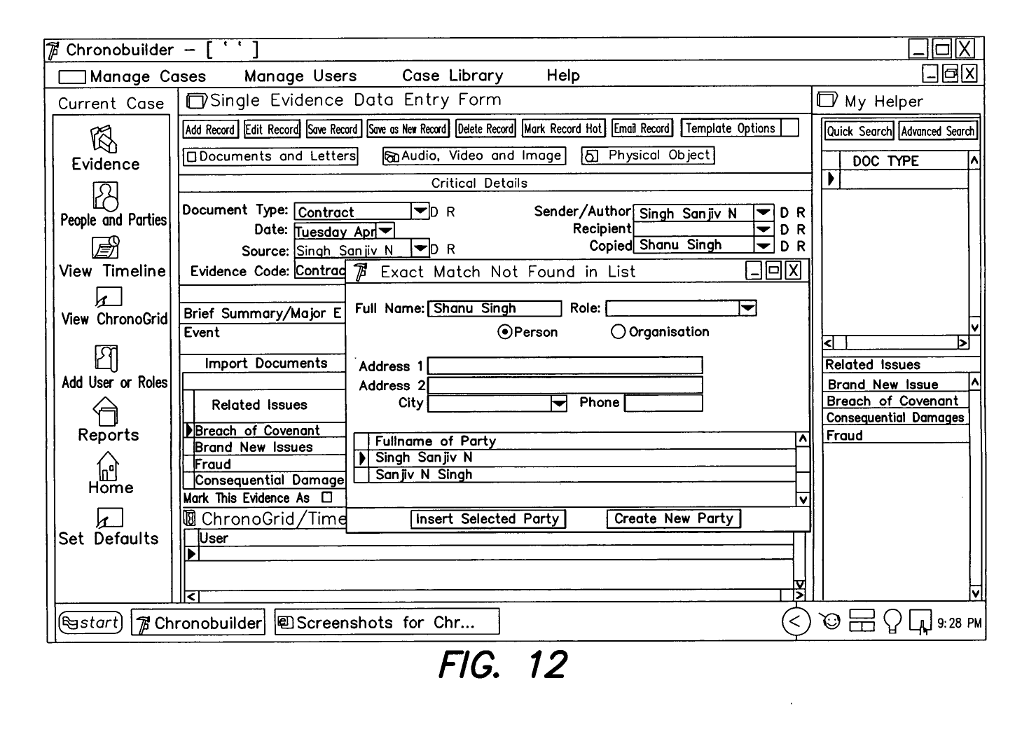

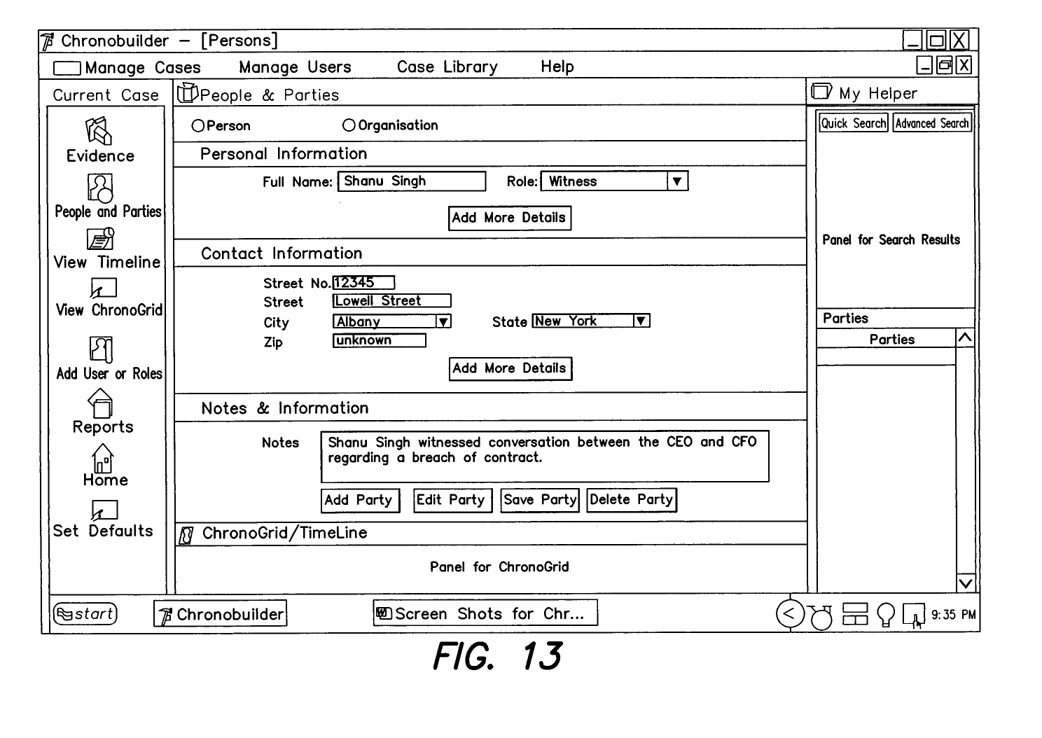

FIG. 12 illustrates the pop-up GUI which permits a data entry agent 102 to add critical details regarding a particular party while entering data for a particular data source 101/1401 on the principal evidence entry GUI 104A. The same critical details for such party, whether person or organization or other entity, may be entered by means of the stand-alone GUI illustrated in FIG. 13 which permits a data entry agent 102 to add people and parties to a particular matter at any time. By use of either the stand-alone GUI illustrated in FIG. 13 or by use of the pop-up GUI illustrated in FIG. 12, a data entry agent 102 may record the critical details for a particular party, organization, or other such entity and thereby ensure that such linkable data becomes part of the scroll down menus contained in the key information prompts 104C appearing on applicable data entry GUIs occurring throughout use of the program. This finctionality is critical to ensure data homogenization and to ensure data linkage as described above.

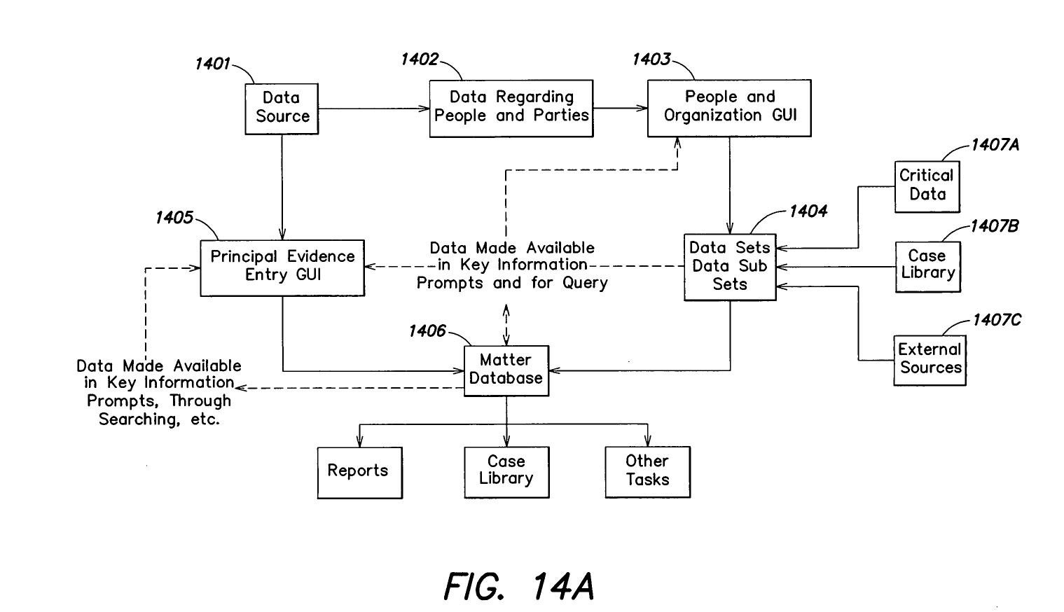

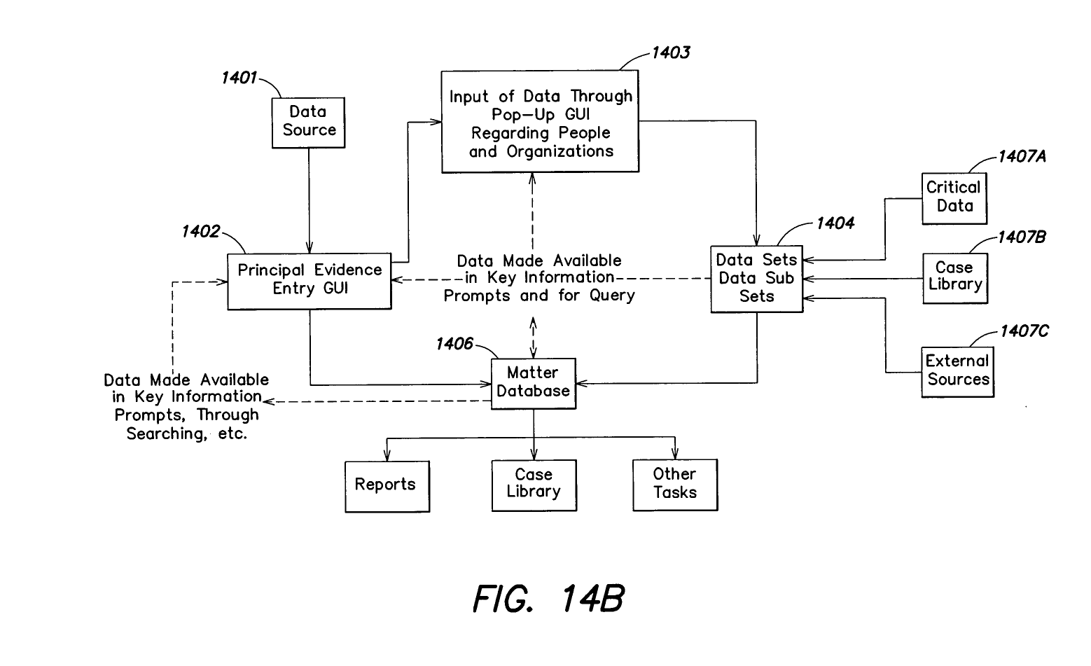

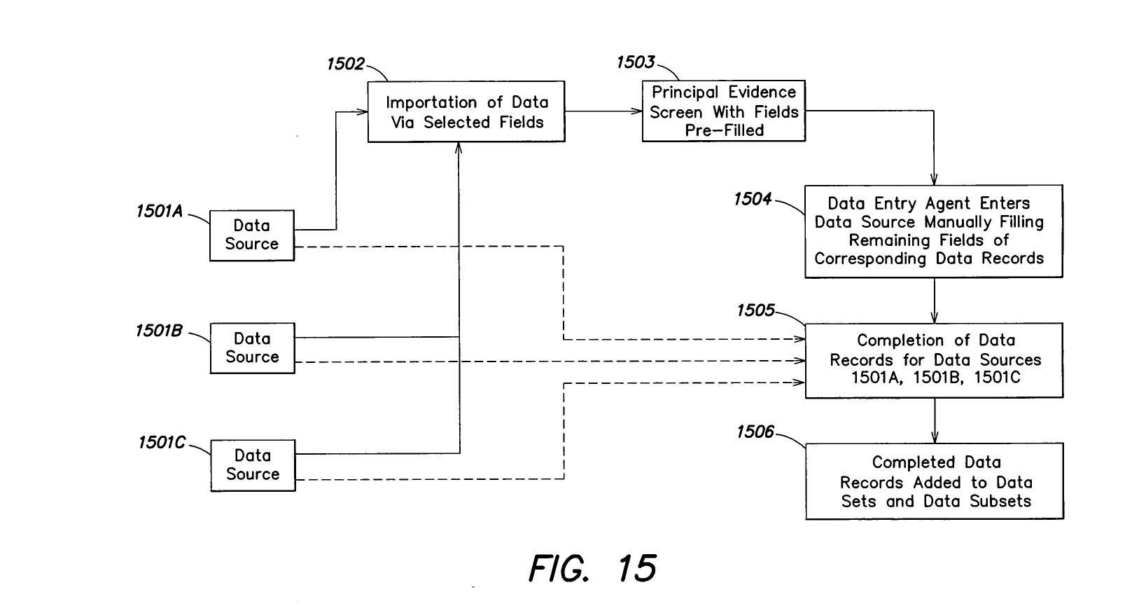

FIG. 14A and FIG. 14B are flow diagrams which illustrate the two principal methods for entering people and organizations and other such entities from data sources 101/1401. In the first method illustrated in FIG. 14A, people and parties are entered through use of the people and organization stand-alone GUI illustrated in FIG. 13 prior to or concurrent with any of the data sources 101/1401 being entered through the principal evidence entry graphical user interface 104A/1405 on FIG. 14A. In the second method illustrated in FIG. 14B, people and organizations and other such entities are entered as appropriate when data (entered through key information prompts 104C of the principal evidence entry GUI 104A/1402 on FIG. 14B or other such interfaces) does not match the names of people and parties already contained in the data sets and data subsets 1404 within the matter database 1406 of the particular matter.

The first method illustrated in FIG. 14A enables data entry agents to subsequently focus on entry of Tier 2 and Tier 3 information as contained in the principal evidence entry graphical user interface 104A also illustrated in FIG. 5 by utilizing the scroll down menus to access the names of people and parties which have previously been, or concurrently are being, entered through the people and organizations stand-alone GUI illustrated in FIG. 13. The second method illustrated in FIG. 14B permits easy addition of people and parties during entry and is particularly suited to new matters and matters where the data entry agents 102 may not know who the relevant people, organizations, and/or other such entities are but will learn about the them during the course of review of data sources 101/1401 in a particular case or matter.

A third method may be utilized to enter people and parties (and other information) for a particular matter. In this third method, people, organizations, and other such entities already stored in the law firm case database/case library 106/1407B may be uploaded to a particular matter so that such information become part of the data sets and data subsets 1404 stored in the matter database 105/1406 for that particular matter. In an exemplary embodiment of this invention, the third method and/or system may also permit uploading of people, organization and other data that has not been necessarily processed by the systems and methods embodied by this invention but may alternatively reside in the conflicts database for a firm or agency, or other such external data sources 1407C such as electronic documents, EDGAR files, etc. FIG. 15 illustrates the data flow of importation; details of such importation are also described in detail above in connection with EDGAR documents as an exemplary embodiment.

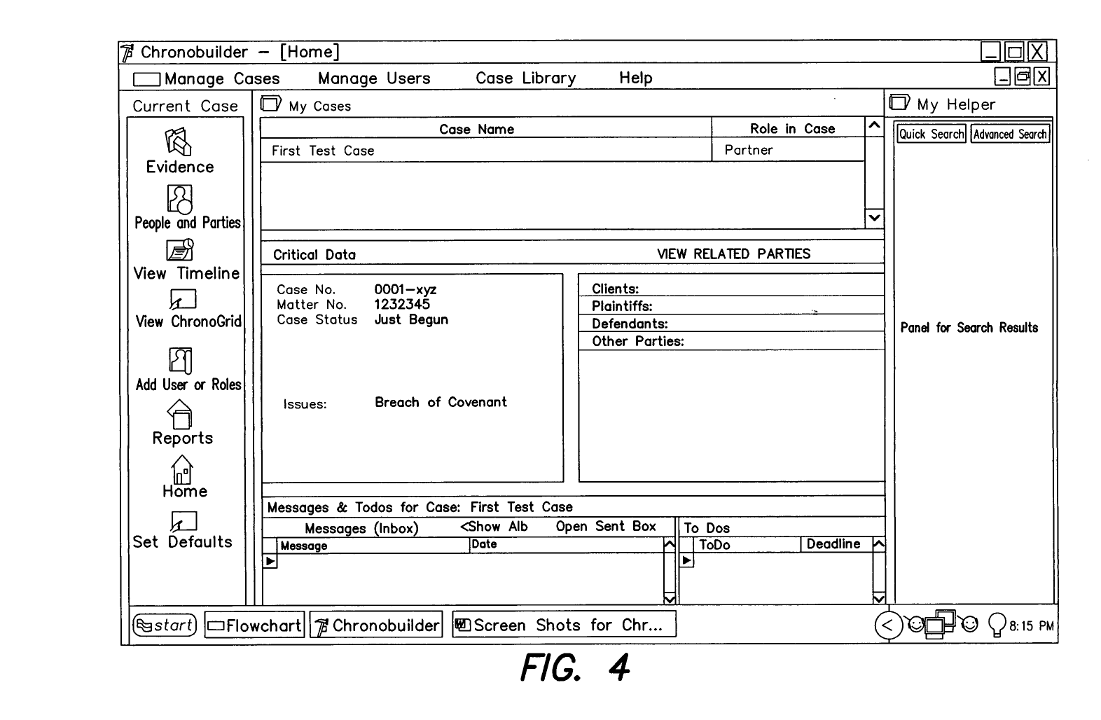

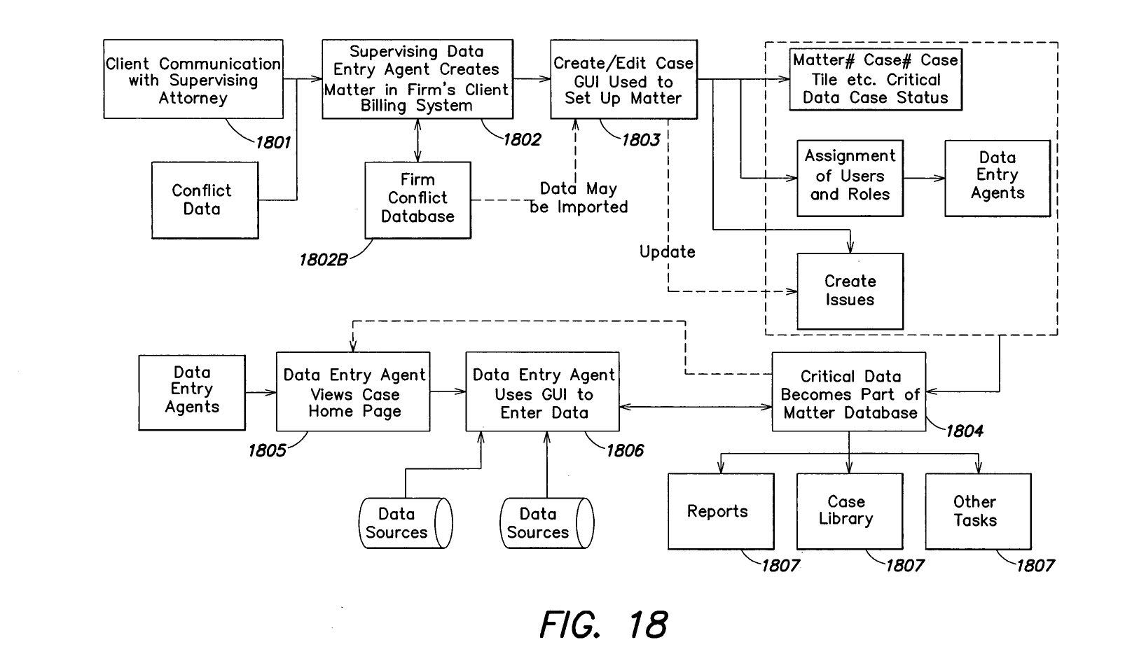

FIG. 16 illustrates an embodiment of the graphical user interface which permits a data entry agent to create a matter, modify critical data of a matter, close a matter, or to assign data entry agents and their roles. FIG. 18 illustrates the flow of critical data once entered. In summary, the critical data, once entered by a supervising data entry agent 102A in the critical data GUI 103 (see also 1801. 1802, 1803 and FIG. 16) is used in the following ways: (i) to save names of parties and organizations and issue lists in the matter database 1804, and thereby make such data available for term recognition/data homogenization, issue analysis and linking purposes through various data entry graphical user interfaces 1806 or reports 1807, case libraries 1807, and other such access points (ii) to compare and coordinate names and related data with external databases, such as the law firms own external conflicts database 1802B (iii) to set the number of data entry agents 102, the identity of those data entry agents 102, and the roles of the data entry agents 102 for the particular matter (iv) to define critical details (billing numbers, corporate information, etc) which may be later used for administrative purposes (v) to define critical legal issues so that key legal issues are included in appropriate screens including: Tier 3 of the principal evidence entry GUI 104A, all data entry GUIs 1806, or the Case Home Page 1805 also illustrated in FIG. 4 which every data entry agent 102 and others may see (vi) to customize and/or add key information prompts 104C as desired (vii) to set the status of the case (see FIG. 16) so that data entry agents are informed as to whether the case is still active, whether review has been suspended, etc.

FIG. 16A illustrates an embodiment of the pop-up graphical user interface which a data entry agent would access while creating, editing, or modifying a matter (i.e. when using the graphical user interface described in the previous paragraph and illustrated in FIG. 16) and thereby be able to add additional data entry agents to a matter, delete data entry agents from a matter, and define roles and privileges for data entry agents for a particular matter. The supervising data entry agent 103 must itself be authorized to make changes using this interface; only a partner or other supervising data entry agent 103 (such as a senior associate) or a data entry agent 102 authorized by a partner or supervising data entry agent 103 (i.e. a paralegal or secretary) would be able to define, add, delete users and/user roles amongst data entry agents.

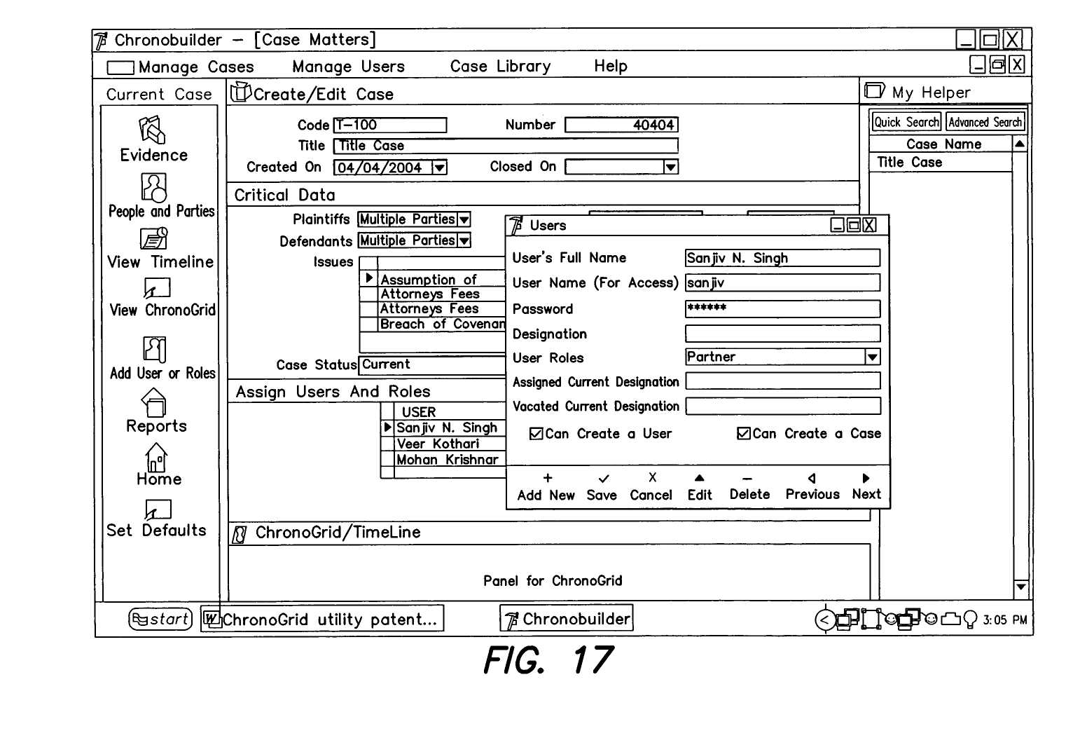

FIG. 17 illustrates an embodiment of the graphical user interface used to add data entry agents to the firm. For example, when a firm first acquires the product that embodies this system and method, and installs such product in its network or computers, such an interface would appear to enable a firm administrator or supervising data entry agent to manually add other data entry agents 102 or users to the total list of users who may be assigned within any matter which is created. In preferred embodiments, personnel data from external databases could be uploaded to automatically add multiple users or data entry agents 102 to the firm's list of possible data entry agents for any particular matter. Such external databases would include human resource databases, personnel records, and other such configurations. The importation of this data would proceed in a similar fashion to the import of other electronic data as illustrated in FIG. 15.

It is contemplated that embodiments of the present invention may be readily produced, by one of ordinary skill in the art, to be used in a wide range of non-legal investigative fields. For example, cases or matters could consist of historical, medical, auditing, accounting, exploratory, genealogical, scientific, epidemiological, or other such matters where single or multiple data entry agents (including but not limited to historians, physicians, scientists, coroners, accountants, auditors, insurance inspectors, city officials, police, museum staff, explorers, naturalists, etc.) could access data entry graphical user interfaces similar to the principal evidence entry GUI 104A and other GUI's described in this application where the key information prompts 104C of such interfaces have been tailored for specific kinds of data sources 101 by one of ordinary skill in the art to produce an embodiment of the present invention for specific investigative disciplines. In the corporate field, it is specifically contemplated that embodiments of the present invention may be produced for use in both legal and non-legal corporate due diligence, again with modification to the content of the key information prompts 104C and certain content of the graphical user interfaces.

Although the present invention has been described in some detail by way of illustration and example for purposes of clarity and understanding, it will, of course, be understood that various changes and modifications may be made in the form, details, and arrangement of the parts without departing from the scope of the invention set forth in the following claims. The foregoing are intended to be encompassed herein, as limited only by the claims.

1. A method of handling data from multiple data sources for a legal matter, comprising:
selecting a plurality of key information prompts relating to and incorporating information identified in a preliminary review of critical data that is pertinent to a legal matter, wherein the key information prompts direct data entry agents to collect specific kinds of data that is pertinent to the legal matter;
entering data from data sources through the key information prompts;
associating the data with the key information prompts;
storing the data in linkable, discrete packets;
storing such packets in data sets and data subsets; and
organizing the data sets and data subsets in a matter database.

2. A method of claim 1, further comprising presenting the data in a report.

3. A method of claim 2, wherein a viewer of the report may select the organization of the report by various parameters.

4. A method of claim 2, wherein a viewer of the report may view the report in real-time while entering data.

5. A method of claim 2, wherein a viewer of the report may cross-navigate between the report and corresponding data entry screens.

6. A method of claim 1, further comprising organizing matter databases to form case libraries where data from one matter database may be linkable or importable to data from another matter database.

7. A method of claim 1, wherein the key information prompts relate to at least one of case critical data, contact information, data relating to parties to the legal matter, data relating to witnesses to legal matters, data relating to counsel for parties, data relating to a court, data relating to a judge, data relating to a date, data relating to a time, data relating to a sequence of events, data relating to a fact, data relating to a statement, data relating to an item of evidence, data relating to an entity, data relating to an institution, data relating to a legal issue, and data relating to a company.

8. A method of claim 1, further comprising enabling a user to analyze the data.

9. A method of claim 8, wherein permitting a user to analyze the data includes at least one of permitting linkage of data, term recognition of newly imported data, data queries, and data homogenization.

10. A method of claim 1, further comprising providing a data entry graphical user interface which includes specified key information prompts for specific kinds of data collection.

11. A method of claim 10, wherein the data entry graphical user interface includes a tiered data entry space.

12. A method of claim 11, wherein the tiered data entry space includes a first tier addressing critical details of the data source.

13. A method of claim 12, wherein the critical details are selected from the group consisting of a date, a document code, an evidence code, a source, a document type, an object type, a media type, an author, a contracting party, a narrator, an interviewer, a copied party, a receiving party, a sending party, an owner, a party mentioned, a location, and a dimension.

14. A method of claim 11, wherein the tiered data entry space includes a tier permitting detailed textual summary of the data source.

15. A method of claim 11, wherein the tiered data entry space includes a tier permitting analysis of legal issues.

16. A method of claim 11 wherein the tiered data entry space includes a tier for commentary between data entry agents related to the data source and matter.

17. A method of claim 10, wherein the data entry graphical user interface fits in an active space that is viewed on the same screen as a real-time generation of the report.

18. A method of claim 17, where such report contains cells or rows that are actively linked to specific records which appear in the data entry graphical user interface space.

19. A method of claim 10, wherein key information prompts of the graphical user interface address data captured from at least one of an interview, a deposition, a telephone call and a meeting.

20. A method of claim 10, where the data entry graphical user interface may be adjusted through editing of certain key information prompts so that the data entry graphical user interface is thereby customized for collection of specific classes of data sources where such classes of data sources are selected from the group consisting of audio data sources, video or visual data sources, and data sources represented by tangible objects.

21. A method of claim 10, further comprising a pop-up graphical user interface for data entry of people, organizations and other entities that appears at any instance where a data entry agent enters the name of at least one of a person, an organization, and an entity in the data entry graphical user interface and such name does not appear in at least one of the matter database and corresponding scroll-down menus of the key information prompts residing in such data entry graphical user interface.

22. A method of claim 1, wherein the gathering of preliminary data includes a supervising data entry agent determining and assigning a finite number of legal issues for a particular matter to be analyzed for each data source by certain authorized data entry agents working on such matter.

23. A method of claim 22, wherein the supervising data entry agent can select issues from an issue database that resides in the system described by this invention.

24. A method of claim 22, wherein the data entry agents can suggest new issues.

25. A method of claim 24, wherein such issues are marked as pending.

26. A method of claim 24, wherein a supervisor can review such issues.

27. A method of claim 22, wherein the data entry agents can select new issues from the issue database.

28. A method of claim 27, wherein such issues are marked as pending.

29. A method of claim 28, wherein a supervisor can approve such issues.

30. A method of claim 10, wherein the data entry graphical user interface may be represented by other combinations of key information prompts which are embodied in pop-up graphical interfaces.

31. A method of claim 30, wherein the key information prompts are embodied in separate graphical user interfaces functioning independently of other graphical user interfaces.

32. A method of claim 1, where a pop-up graphical user interface appears during entry of data to permit multiple entries of data linkable to the same data source and its corresponding data record within the matter database.

33. A method of claim 1, wherein the data sources are selected from the group consisting of documents, word processing files, spreadsheets, presentations, email documents, instant messaging documents, audio media, tapes, CDs, MP3 files, .wav files, sound files, video media, VHS tapes, BETA tapes, DVDs, streaming video files, microfiche, microfilm, data storage facilities, relational databases, data repositories, data marts, object-oriented databases, disks, mass storage media, servers, jump drives, flash memory, and memory sticks.

34. A method of claim 1, whereby authorized data entry agents are determined by the roles and privileges defined by supervising data entry agents(s).

35. A method of claim 1, wherein the data entry agent is selected from the group consisting of an attorney, an associate, a partner, an employee, a consultant, a student, an intern, a government official, a volunteer, an attendant, a team member, a system administrator, a contractor, a vendor, an accountant, an auditor, a private investigator, a principal, an administrator, a paralegal, a law enforcement official, a risk analyst, a secretary, a document manager, litigation support staff personnel, an authorized user and a non-authorized user.

36. A method of claim 1, wherein the key information prompt is selected from a group consisting of object type, document type, media type, event, date, data source, brief description, detailed description, evidence code, bates code, party's address, parties copied, recipient, sender, author, legal comments, issue analysis, a privileged notation, and a sensitive notation.

37. A method of claim 2, wherein the report may be viewed in real-time, while data is entered, on the same screen as the key information prompts.

38. A method of claim 10, further comprising providing a report, wherein the report contains cells or links which correlate to key information data fields appearing on a corresponding graphical user interface where such user interface may be accessed and simultaneously viewed through clicking on a link.

39. A method of claim 38, wherein the report consists of a four column chronogrid showing events/evidence, description of events/evidence, parties, and legal comments.

40. A method of claim 2, wherein the report relates to performance of data entry agents.

41. A method of claim 2, wherein the report relates to linkage of at least one of a key fact, an issue, an event, a date, a person, an organization, and a data source.

42. A system of handling data from multiple data sources for a legal matter, comprising:
a data facility for selecting a plurality of key information prompts relating to and incorporating information identified in a preliminary review of critical data that is pertinent to a legal matter, wherein the key information prompts direct data entry agents to collect specific kinds of data that is pertinent to the legal matter;
an extension of the data facility for entering data from data sources through the key information prompts;
an extension of the data facility for associating the data with the key information prompts;
an extension of the data facility for storing the data in linkable, discrete packets;
an extension of the data facility for storing such packets in data sets and data subsets; and
an extension of the data facility for organizing the data sets and data subsets in a matter database.

43. A system of claim 42, further comprising presenting the data in a report.

44. A system of claim 43, wherein a viewer of the report may select the organization of the report by various parameters.

45. A system of claim 43, wherein a viewer of the report may view the report in real-time while entering data.

46. A system of claim 43, wherein a viewer of the report may cross-navigate between the report and corresponding data entry screens.

47. A system of claim 44, further comprising organizing matter databases to form case libraries where data from one matter database may be linkable or importable to data from another matter database.

48. A system of claim 42, wherein the key information prompts relate to at least one of case critical data, contact information, data relating to parties to the legal matter, data relating to witnesses to legal matters, data relating to counsel for parties, data relating to a court, data relating to a judge, data relating to a date, data relating to a time, data relating to a sequence of events, data relating to a fact, data relating to a statement, data relating to an item of evidence, data relating to an entity, data relating to an institution, data relating to a legal issue, and data relating to a company.

49. A system of claim 42, further comprising enabling a user to analyze the data.

50. A system of claim 49, wherein permitting a user to analyze the data includes at least one of permitting linkage of data, term recognition of newly imported data, data queries, and data homogenization.

51. A system of claim 42, further comprising providing a data entry graphical user interface which includes specified key information prompts for specific kinds of data collection.

52. A system of claim 51, wherein the data entry graphical user interface includes a tiered data entry space.

53. A system of claim 52, wherein the tiered data entry space includes a first tier addressing critical details of the data source.

54. A system of claim 53, wherein the critical details are selected from the group consisting of a date, a document code, an evidence code, a source, a document type, an object type, a media type, an author, a contracting party, a narrator, an interviewer, a copied party, a receiving party, a sending party, an owner, a party mentioned, a location, and a dimension.

55. A system of claim 52, wherein the tiered data entry space includes a tier permitting detailed textual summary of the data source.

56. A system of claim 52, wherein the tiered data entry space includes a tier permitting analysis of legal issues.

57. A system of claim 52 wherein the tiered data entry space includes a tier for commentary between data entry agents related to the data source and matter.

58. A system of claim 51, wherein the data entry graphical user interface fits in an active space that is viewed on the same screen as a real-time generation of the report.

59. A system of claim 58, where such report contains cells or rows that are actively linked to specific records which appear in the data entry graphical user interface space.

60. A system of claim 51, wherein key information prompts of the graphical user interface address data captured from at least one of an interview, a deposition, a telephone call and a meeting.

61. A system of claim 51, where the data entry graphical user interface may be adjusted through editing of certain key information prompts so that the data entry graphical user interface is thereby customized for collection of specific classes of data sources where such classes of data sources are selected from the group consisting of audio data sources, video or visual data sources, and data sources represented by tangible objects.

62. A system of claim 51, further comprising a pop-up graphical user interface for data entry of people, organizations and other entities that appears at any instance where a data entry agent enters the name of at least one of a person, an organization, and an entity in the data entry graphical user interface and such name does not appear in at least one of the matter database and corresponding scroll-down menus of the key information prompts residing in such data entry graphical user interface.

63. A system of claim 42, wherein the gathering of preliminary data includes a supervising data entry agent determining and assigning a finite number of legal issues for a particular matter to be analyzed for each data source by certain authorized data entry agents working on such matter.

64. A system of claim 63, wherein the supervising data entry agent can select issues from an issue database that resides in the system described by this invention.

65. A system of claim 63, wherein the data entry agents can suggest new issues.

66. A system of claim 65, wherein such issues are marked as pending.

67. A system of claim 65, wherein a supervisor can review such issues.

68. A system of claim 63, wherein the data entry agents can select new issues from the issue database.

69. A system of claim 68, wherein such issues are marked as pending.

70. A system of claim 69, wherein a supervisor can approve such issues.

71. A system of claim 51, wherein the data entry graphical user interface may be represented by other combinations of key information prompts which are embodied in pop-up graphical interfaces.

72. A system of claim 71, wherein the key information prompts are embodied in separate graphical user interfaces functioning independently of other graphical user interfaces.

73. A system of claim 42, where a pop-up graphical user interface appears during entry of data to permit multiple entries of data linkable to the same data source and its corresponding data record within the matter database.

74. A system of claim 42, wherein the data sources are selected from the group consisting of documents, word processing files, spreadsheets, presentations, email documents, instant messaging documents, ,audio media, tapes, CDs, MP3 files, .wav files, sound files, video media, VHS tapes, BETA tapes, DVDs, streaming video files, microfiche, microfilm, data storage facilities, relational databases, data repositories, data marts, object-oriented databases, disks, mass storage media, servers, jump drives, flash memory, and memory sticks.

75. A system of claim 42, whereby authorized data entry agents are determined by the roles and privileges defined by supervising data entry agents(s).

76. A system of claim 42, wherein the data entry agent is selected from the group consisting of an attorney, an associate, a partner, an employee, a consultant, a student, an intern, a government official, a volunteer, an attendant, a team member, a system administrator, a contractor, a vendor, an accountant, an auditor, a private investigator, a principal, an administrator, a paralegal, a law enforcement official, a risk analyst, a secretary, a document manager, litigation support staff personnel, an authorized user and a non-authorized user.

77. A system of claim 42, wherein the key information prompt is selected from a group consisting of object type, document type, media type, event, date, data source, brief description, detailed description, evidence code, bates code, party's address, parties copied, recipient, sender, author, legal comments, issue analysis, a privileged notation, and a sensitive notation.

78. A system of claim 43, wherein the report may be viewed in real-time, while data is entered, on the same screen as the key information prompts.

79. A system of claim 51, further comprising providing a report, wherein the report contains cells or links which correlate to key information data prompts appearing on the corresponding graphical user interface where such user interface may be accessed and simultaneously viewed through clicking on a link.

80. A system of claim 79 wherein the report consists of a four column chronogrid showing events/evidence, description of events/evidence, parties, and legal comments.

81. A system of claim 43, wherein the report relates to performance of data entry agents.

82. A system of claim 43, wherein the report relates to linkage of at least one of a key fact, an issue, an event, a date, a person, an organization, and a data source.
